(19) United States
(12) Patent Application Publication
(10) Pub. No.: US 2022/0310066 A1
(43) Pub. Date: Sep. 29, 2022

(54) ELECTRONIC DEVICE FOR PERFORMING TASK CORRESPONDING TO VOICE COMMAND AND OPERATION METHOD THEREFOR

(71) Applicant: Samsung Electronics Co., Ltd., Suwon-si, Gyeonggi-do (KR)

(72) Inventor: Sunghwan CHOI, Suwon-si (KR)

(21) Appl. No.: 17/288,331

(22) PCT Filed: Mar. 25, 2021
(86) PCT No.: PCT/KR2021/003688

§ 371 Date: Apr. 23, 2021

(30) Foreign Application Priority Data
Apr. 3, 2020 (KR) 10-2020-0041025

(51) Int. Cl. G10L 15/08; G06F 40/279

(52) U.S. Cl. CPC G10L 15/08; G06F 40/279

(57) ABSTRACT

An electronic device according to an embodiment may include: a microphone for converting an external voice to voice data; a communication circuit; and at least one processor operatively connected to the microphone and the communication circuit, wherein the at least one processor is configured to: identify, from the voice data received from the microphone, a trigger voice configured to trigger a voice command function of the electronic device; acquire, from an external electronic device through the communication circuit, a communication signal including information indicating output of content including the trigger voice from the external electronic device; and skip processing of additional voice data acquired from the microphone after the trigger voice when output of content including the trigger voice from the external electronic device is identified based on the communication signal, and the trigger voice is identified from the voice data. A voice recognition method of the electronic device may be performed by means of an artificial intelligence model.

### CROSS-REFERENCE TO RELATED APPLICATION(S)

This application is a U.S. National Stage application under 35 U.S.C. § 371 of an International application number PCT/KR2021/003688, filed on Mar. 25, 2021, which is based on and claims priority of a Korean patent application number 10-2020-0041025, filed on Apr. 3, 2020, in the Korean Intellectual Property Office, the disclosure of which is incorporated by reference herein in its entirety.

### BACKGROUND

### 1. Field

An embodiment of the disclosure relates to an electronic device for performing a task corresponding to a voice command and an operation method therefor.

### 2. Description of the Related Art

Recently, artificial intelligence speakers have been actively introduced. The artificial intelligence speakers are arranged in various living spaces and may wait for a voice command from a user. The artificial intelligence speaker may respond to a call command from the user. After the artificial intelligence speaker responds, the user may utter an additional voice. The artificial intelligence speaker may convert the voice into voice data through a microphone. The artificial intelligence speaker may process the voice data and perform an operation corresponding to the result of the processing. For example, the artificial intelligence speaker may perform voice recognition and perform a task corresponding to the voice recognition. Alternatively, the artificial intelligence speaker may request an AI server to perform voice recognition. The AI server may perform a task corresponding to the voice recognition, or may provide information relating to an operation for performing a task to the artificial intelligence speaker. The artificial intelligence speaker may output the result of the processing in a voice. Accordingly, the user may speak a voice command and listen to a voice response thereto, and thus a voice command through a conversation can be performed.

### SUMMARY

A media device for outputting a voice, such as a TV, may be disposed together in a space in which an artificial intelligence speaker is disposed. For example, the media device may output a voice including a call command and/or a voice command. In this case, the artificial intelligence speaker is not able to distinguish whether the corresponding voice is uttered by a user or is output from the media device. Accordingly, a voice output from the media device is processed, which may cause a task that is not desired by a user to be performed. For example, when a voice commanding a purchase of a particular article is output from the media device, the particular article that is not desired by the user may be purchased.

Various embodiments of the disclosure relate to an electronic device for determining whether a voice command is processed, based on information from a media device, and an operation method therefor.

According to an embodiment, an electronic device may include: a microphone configured to convert an external voice into voice data; a communication circuit; and at least one processor operatively connected to the microphone and the communication circuit, wherein the at least one processor is configured to: identify, from the voice data received from the microphone, a trigger voice configured to trigger a voice command function of the electronic device; acquire, from an external electronic device through the communication circuit, a communication signal including information indicating output of content including the trigger voice from the external electronic device; and skip processing of additional voice data acquired from the microphone after the trigger voice when output of content including the trigger voice from the external electronic device is identified based on the communication signal and the trigger voice is identified from the voice data.

According to an embodiment, a media device may include: a speaker configured to convert an electrical signal into a voice and output the converted voice; a communication circuit; and at least one processor operatively connected to the speaker and the communication circuit, wherein the at least one processor is configured to: acquire a media file; control, by using information corresponding to the media file, output of a voice corresponding to the media file by means of the speaker; identify that the voice corresponding to the media file includes a pre-designated trigger voice; and control the communication circuit to transmit, to an external electronic device, a communication signal including information indicating that the voice corresponding to the media file includes the trigger voice.

According to an embodiment, an electronic device may include: a microphone configured to convert an external voice into voice data; a communication circuit; and at least one processor operatively connected to the microphone and the communication circuit, wherein the at least one processor is configured to: identify a command from the voice data received from the microphone; receive, from an external electronic device through the communication circuit, information relating to a media file that is being output from the external electronic device; identify whether the voice data corresponds to the information relating to the media file that is being output from the external electronic device; process the command when the voice data fails to correspond to the information relating to the media file that is being output from the external electronic device; and skip the processing of the command when the voice data corresponds to the information corresponding to the media file that is being output from the external electronic device.

According to an embodiment, a media device may include: a speaker configured to convert an electrical signal into a voice and output the converted voice; a communication circuit; and at least one processor operatively connected to the speaker and the communication circuit, wherein the at least one processor is configured to: acquire a media file; control, by using information corresponding to the media file, output of a voice corresponding to the media file by means of the speaker; and transmit, to an external electronic device through the communication circuit, information relating to the media file that is being output from the media electronic device.

According to an embodiment, a method for operating an electronic device, the electronic device including: a microphone configured to convert an external voice into voice data; a communication circuit; and at least one processor operatively connected to the microphone and the communication circuit, may include: identifying, from the voice data received from the microphone, a trigger voice configured to trigger a voice command function of the electronic device; acquiring, from an external electronic device through the communication circuit, a communication signal including information indicating output of content including the trigger voice from the external electronic device; and skipping processing of additional voice data acquired from the microphone after the trigger voice when output of content including the trigger voice from the external electronic device is identified based on the communication signal and the trigger voice is identified from the voice data.

Various embodiments of the disclosure provide an electronic device for determining whether a voice command is processed, based on information from a media device, and an operation method therefor. Accordingly, the disclosure can reduce likelihood that a task corresponding to a voice output from the media device is erroneously performed.

### BRIEF DESCRIPTION OF THE DRAWINGS

FIG. 1 illustrates an Internet of Things (IoT) system according to an embodiment.

FIG. 2 illustrates an IoT server and a voice assistance server according to an embodiment.

FIG. 3 illustrates an IoT server and an edge computing system according to various embodiments.

FIG. 4 is a flow chart illustrating an operation between clouds according to an embodiment.

FIG. 5 illustrates an electronic device, a media device, and an AI server according to an embodiment.

FIG. 6 is a flow chart illustrating a method for operating an electronic device and a media device according to an embodiment.

FIG. 7A is a block diagram illustrating an electronic device and a media device according to an embodiment.

FIG. 7B is a block diagram illustrating an electronic device and a media device according to an embodiment.

FIG. 8 is a flow chart illustrating a method for operating an electronic device according to an embodiment.

FIG. 9 is a flow chart illustrating a method for operating an electronic device according to an embodiment.

FIG. 10 is a flow chart illustrating a method for operating an electronic device and a media device according to an embodiment.

FIG. 11 illustrates operations of an electronic device and a media device according to an embodiment.

FIG. 12 is a flow chart illustrating a method for operating an electronic device and a media device according to an embodiment.

FIG. 13 illustrates information relating to a media file according to an embodiment.

FIG. 14 is a flow chart illustrating a method for operating an electronic device, an AI server, and a media device according to an embodiment.

### DETAILED DESCRIPTION

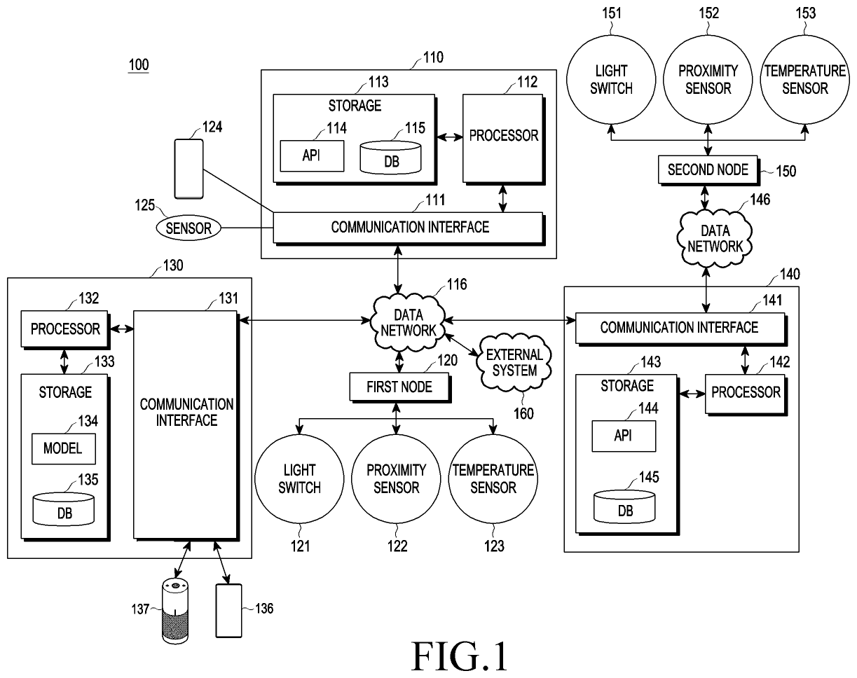

FIG. 1 illustrates an Internet of Things (IoT) system 100 according to an embodiment. At least a part of a component of FIG. 1 may be omitted, or a component that is not shown may be further included.

Referring to FIG. 1, the IoT system 100 according to an embodiment may include at least one of a first IoT server 110, a first node 120, a voice assistance server 130, a second IoT server 140, a second node 150, or devices 121, 122, 123, 124, 125, 136, 137, 151, 152, and 153.

According to an embodiment, the first IoT server 110 may include at least one of a communication interface 111, a processor 112, or a storage 113. The second IoT server 140 may include at least one of a communication interface 141, a processor 142, or a storage 143. For example, the “IoT server” in this document may remotely control and/or monitor, based on a data network (e.g., a data network 116 or a data network 146), one or more devices (e.g., devices 121, 122, 123, 124, 125, 151, 152, and 153) through a relay device (e.g., the first node 120 or the second node 150), or directly without the relay device. Here, the “device” is, for example, a device for performing a process, a home or office electronic device, or a sensor disposed (or located) in an environment such as a house, an office, a factory, a building, an external branch, or other types of sites, but is not limited in type. The device may receive an instruction from the outside (e.g., an IoT server) so as to perform an operation corresponding to the instruction, or may provide, based on an external request or satisfaction of a designated condition, requested information (for example, sensed information) to the outside. The device which receives a control command and perform an operation corresponding to the control command may be referred to as a “target device”. The IoT server may transmit, to a device, at least one of: an instruction causing performing of a particular operation; an instruction for requesting provision of a particular piece of information; an instruction for requesting deletion of a particular piece of information; or an instruction for requesting generation of a particular piece of information, or may receive data from the device. The IoT server may be referred to as a “central server” in that the IoT server selects a target device from among multiple devices and provides a control command.

According to an embodiment, the first IoT server 110 may communicate with the devices 121, 122, and 123 through the data network 116. The data network 116 may mean, for example, a long-range communication network such as the Internet or a computer network (e.g., a local area network (LAN) or a wide area network (WAN)), or may also include a cellular network. For example, the data network 116 may include a cable and at least one communication device for wired connection and/or wireless connection, and may include at least a part of a server which provides a virtualization service when at least one function for communication is virtualized. The data network 116 is not limited in type.

According to an embodiment, the first IoT server 110 may be connected to the data network 116 through the communication interface 111. The communication interface 111 may include a communication device (or a communication module) for supporting communication of the data network 116, and may be integrated into one component (e.g., a single chip), or may be implemented as separate multiple components (e.g., multiple chips). The first IoT server 110 may communicate with the devices 121, 122, and 123 through the first node 120. The first node 120 may receive data from the first IoT server 110 through the data network 116, and may transmit the received data to at least some of the devices 121, 122, and 123. Alternatively, the first node 120 may receive data from at least some of the devices 121, 122, and 123, and may transmit the received data to the first IoT server 110 through the data network 116. The first node 120 may function as a bridge between the data network 116 and the devices 121, 122, and 123. FIG. 1 shows that there is a single first node 120, but it is a simple example, and the number of the first nodes is not limited thereto. The first IoT server 110 may manage a configuration for devices connected to respective nodes and at least one node. The configuration for a device connected to each node may be referred as a “physical graph”. The physical graph may include at least one of a configuration for a device connected to each node, or a configuration for a device (e.g., devices 124 and 125) directly connected to the IoT server. The physical graph may be implemented to in a form in which a connection relationship between devices, an occurring event, and the like are visually displayed, but the implementation format is not limited thereto. The physical graph may be also used to control the device state and the event.

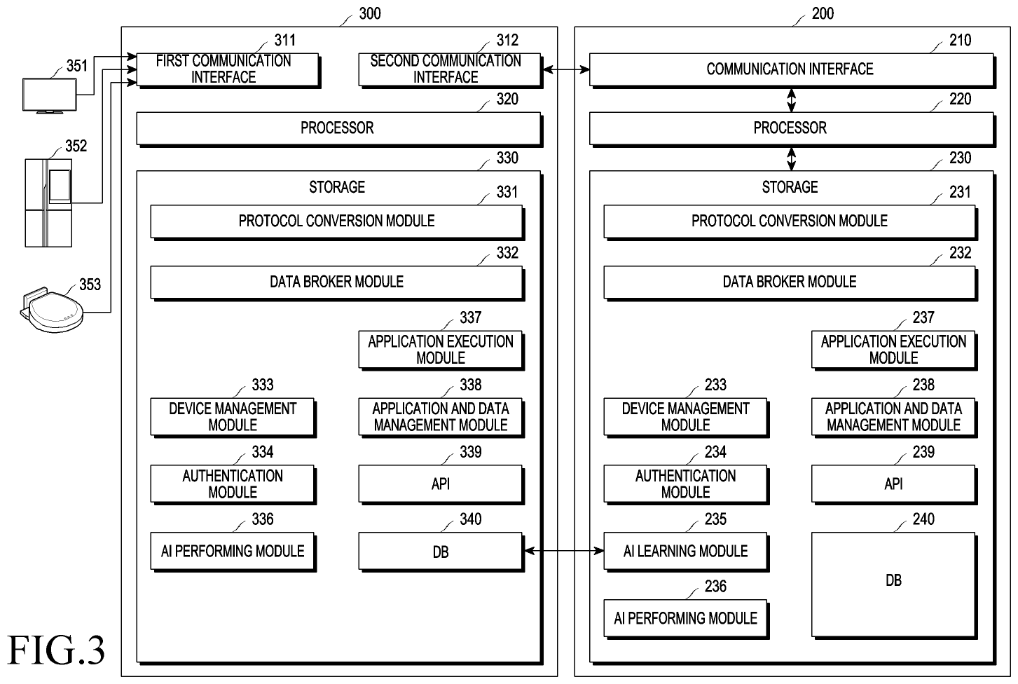

The “node” in this document may be an edge computing system or a hub device. According to an embodiment, the first node 120 may support wired and/or wireless communication of the data network 116, and may also support wired and/or wireless communication with devices 121, 122, and 123. For example, the first node 120 may be connected to the devices 121, 122, and 123 through a short-range communication network such as at least one of Bluetooth, Wi-Fi, Wi-Fi direct, Z-wave, Zig-bee, INSTEON, X10, UWB, or infrared data association (IrDA), but the communication type is not limited thereto. For example, the first node 120 may be disposed (or located) in an environment such as a house, an office, a factory, a building, an external branch, or other types of sites. Accordingly, the devices 121, 122, and 123 may be monitored and/or controlled by a service provided by the first IoT server 110, and the devices 121, 122, and 123 may not be required to have a complete network communication (e.g., Internet communication) capability for direct connection to the first IoT server 110. FIG. 1 shows that the devices 121, 122, and 123 are implemented as an electronic device in a house environment such as a light switch, a proximity sensor, a temperature sensor, and the like, but are illustrative and are not limited thereto. A case in which the first node 120 is implemented as an edge computing system will be described with reference to FIG. 3.

According to an embodiment, the first IoT server 110 may support direct communication with the devices 124 and 125. Here, for example, the “direct communication” may mean communication not through a relay device such as the first node 120, and may be communication through a cellular communication network and/or a data network, for example. For example, the devices 124 and 125 may have a cellular communication capability. Accordingly, the devices 124 and 125 may communicate with the first IoT server 110 through the cellular communication network and/or the data network 116 even away from an area in which the first node 120 is disposed. For example, the sensor 125 may be located in a vehicle, may sense driving speed of the vehicle, and may transmit the same to the first IoT server 110. Alternatively, a smartphone 124 may also transmit user sensing data or a control command to the first IoT server 110. An application for a device control may be executed by the smartphone 124, and a user may control at least some of registered devices by manipulating an execution screen.

According to an embodiment, the first IoT server 110 may transmit a control command to at least one of the devices 121, 122, 123, 124, and 125. Here, the “control command” may mean data causing a controllable device to perform a particular operation, and the particular operation corresponds to an operation performed by a device, and may include information output, information sensing, information reporting, and information management (e.g., deletion or generation), but the particular operation is not limited in type. For example, the processor 112 may acquire information (or a request) for generating a control command from the outside (e.g., at least some of the voice assistance server 130, the second IoT server 140, the external system 160, or devices 121, 122, 123, 124, and 125), and may generate the control command, based on the acquired information. Alternatively, the processor 112 may generate a control command when a monitoring result of at least some of the devices 121, 122, 123, 124, and 125 satisfies a designated condition. The processor 112 may control the communication interface 111 so as to transmit the control command to the target device.

According to an embodiment, the processor 112, a processor 132, or a processor 142 may be implemented in a combination of one or more of a general-purpose processor such as a central processing unit (CPU), a digital signal processor (DSP), an application processor (AP), and a communication processor (CP), a graphics-dedicated processor such as a graphics processing unit (GPU) and a vision processing unit (VPU), or an artificial intelligence-dedicated processor such as a neural processing unit (NPU). The above-described processing units are simple examples, and those skilled in the art will understand that the processor 112 is not limited if the processor 112 corresponds to an operation means which can output an executed result by executing an instruction stored in a storage 113, for example. According to an embodiment, the processor 112 may perform, for example, determination of a target device and/or transfer of a control command. The processor 112 may manage information relating to registered devices, based on a database (DB) 115 stored in the storage 113. For example, the processor 112 may register or delete, based on a user request, at least one target device, corresponding to a particular user account, and may store information relating to a device in the database 115. For example, the user may log on to, based on a dedicated application or a web application, a service provided by the first IoT server 110 with a particular user account by using a laptop computer or a smartphone. In a logged-on state, an electronic device of a user may request, from the first IoT server 110, a service such as target device management, target device operation condition configuration, and control command input for the target device.

According to an embodiment, the processor 112 may perform control command generation and transfer based on an automation application stored in the storage 113. For example, the processor 112 may execute the automation application. The automation application may be, for example, a software component used for controlling or monitoring of devices. The automation application may include, for example, at least one of controls which operate to respond to various types of events occurring in an event handler and/or a system. The event handler may be a software component for servicing an event subscribed by the automation application. For example, the automation application may define an event handler subscribing to an event, and the automation application may be invoked when a particular event occurs.

According to an embodiment, the first IoT server 110 may acquire a request for generating at least one automation application. For example, the first IoT server 110 may generate, based on the generation request, the automation application which can control at least some of the devices 108, based on the particular event. In an example, a user may select one automation application (e.g., light-on) through a user electronic device, and the selected automation application may be configured to turn on the light switch 121, based on the result of proximity sensing by the proximity sensor 122. For example, a “proximate” state of the proximity sensing result may configure an event, and when the light switch 121 is turned on, an action (or action data) may be configured. The processor 112 may transfer, based on the action, a control command to a target device (e.g., the light switch 121).

According to an embodiment, the processor 112 may configure, based on an API 114, a web-based interface, or may expose a resource managed by the first IoT server 110 to the outside. For example, the web-based interface may support communication between the first IoT server 110 and an external web service. For example, the processor 112 may allow an external system 160 to control and/or access the devices 121, 122, and 123. For example, the external system 160 may have no association with the system 100, or may be an independent system that is not a part thereof. The external system 160 may be, for example, an external server or a web site. However, security for access to the devices 121, 122, and 123 or a resource of the first IoT server 110 from the external system 160 is required. According to an embodiment, the processor 112 may expose an API end point (e.g., a universal resource location (URL)) having an automation application based on the API 114 to the outside. According to an embodiment, the API end point may be dynamically configured and accordingly, the security can be enhanced. The processor 112 may receive a request through the API end point. The processor 112 may provide the API end point when authentication is completed. For example, the API end point may be uniquely defined for each instance of the automation application. The automation application may define an event handler for servicing an access request received from the external system 160. The processor 112 may also perform user authentication such as OAUTH2. Alternatively, the processor 112 may also request a user to approve access from the outside.

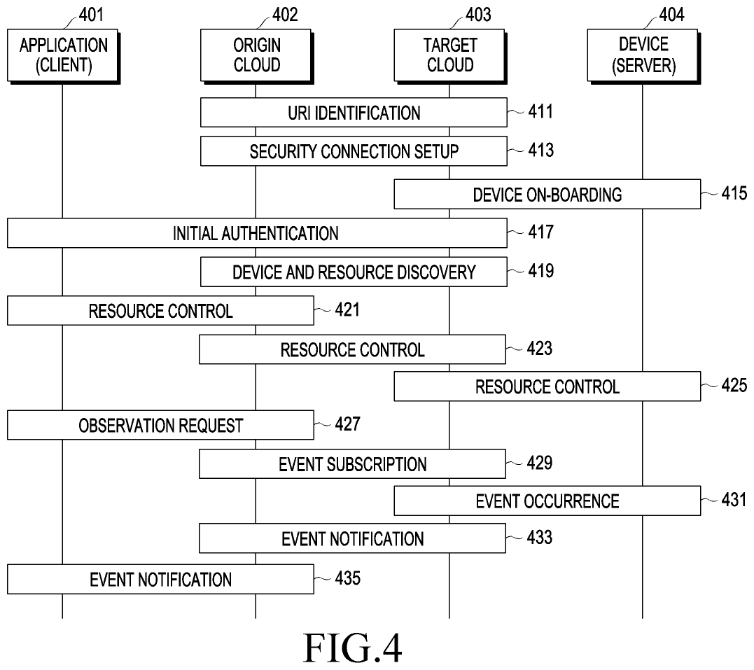

As described above, the first IoT server 110 may transfer a control command to a target device among the devices 121, 122, and 123. Description of a communication interface 141, the processor 142, an API 144 of a storage 143, and a database 145 of the second IoT server 140 may be substantially the same as that of the communication interface 111, the processor 112, the API 114 of the storage 113, and the database 115 of the first IoT server 110. Further, description of the second node 150 may be substantially the same as that of the first node 120. The second IoT server 140 may transfer a control command to a target device among the devices 151, 152, and 153. In one embodiment, the first IoT server 110 and the second IoT serve 140 may be managed by the same service provider, but in another embodiment, the first IoT server 110 and the second IoT serve 140 may be managed by different service providers, respectively. An interaction between IoT servers of the different service providers will be described with reference to FIG. 4.

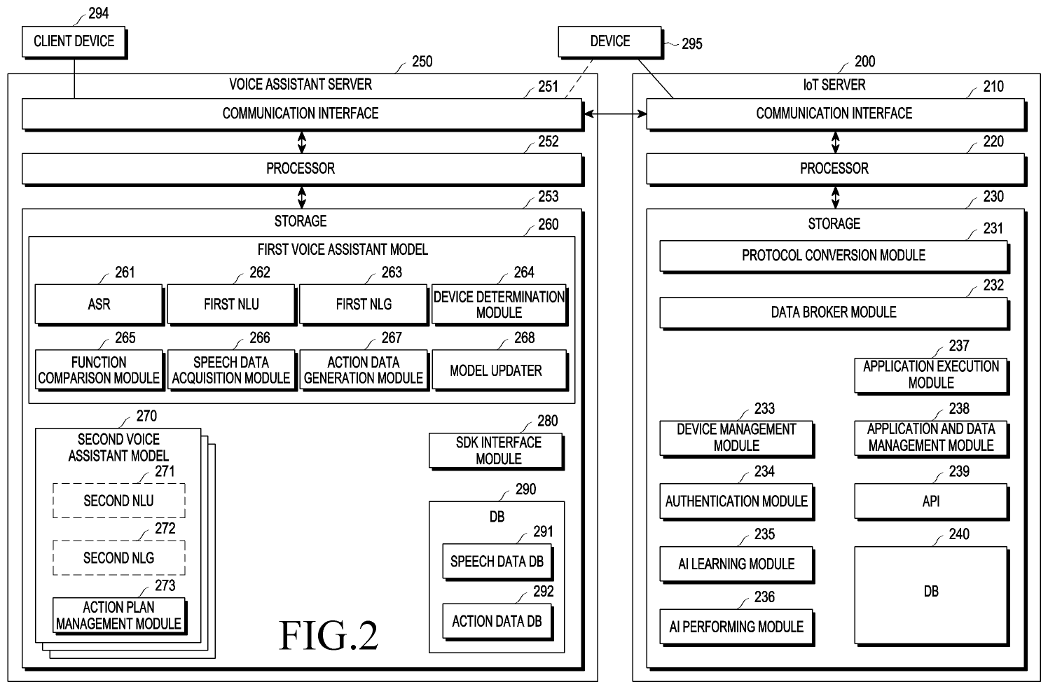

According to an embodiment, the voice assistance server 130 may transmit or receive data to or from the first IoT server 110 through the data network 116. According to an embodiment, the voice assistance server 130 may include at least one of a communication interface 131, a processor 132, or a storage 133. The communication interface 131 may communicate with a smartphone 136 or an AI speaker 137 through a data network (not shown) and/or a cellular network (not shown). The smartphone 136 or the AI speaker 137 may include a microphone, acquire a user voice, convert the acquired user voice into a voice signal, and transmit the converted voice signal to the voice assistance server 130. The processor 132 may receive the voice signal from the smartphone 136 or the AI speaker 137 through the communication interface 131. The processor 132 may process the received voice signal, based on a stored model 134 (e.g., a first voice assistant model 260 and/or a second voice assistant model 270 of FIG. 2). The processor 132 may generate (or identify) a control command by using a processing result, based on information stored in a database 135. For example, the database 135 may store information relating to the connected devices (e.g., the devices 121, 122, and 123). The voice assistance server 130 may receive information relating to a device from the first IoT server 110 through the data network 116 and may store the same. The voice assistance server 130 may generate (or identify) a target device and a control command, based on the information relating to the device and the voice data processing result, and may transmit information relating to the target device and the control command to the first IoT server 110. The first IoT server 110 may identify, based on the received information, the target device and transmit the control command to the identified target device. In another embodiment, the voice assistance server 130 may also transmit the voice data processing result (e.g., a natural language understanding result) to the first IoT server 110. The first IoT server 110 may generate (or identify) a target device or a control command, based on the data processing result. The first IoT server 110 may transmit the control command to the identified target device. As described above, a user may utter a voice in a distance so as to control devices connected to an IoT server. The communication interface 131 is not limited if the communication interface 131 is a device for supporting a data network.

According to an embodiment, the storage 113, 133, or 143 may include at least one type of storage medium of a flash memory type memory, a hard disk type memory, a multimedia card micro type memory, and a card type memory (for example, an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk, and is not limited in type.

FIG. 2 illustrates an IoT server and a voice assistance server according to an embodiment. At least a part of a component of FIG. 2 may be omitted, or a component that is not shown may be further included.

A system for providing a voice assistant service according to an embodiment may include a client device 294, at least one device 295, a voice assistant server 250, and an IoT server 200. The at least one device 295 may be a device pre-registered in the voice assistant server 250 and/or the IoT server 200 for a voice assistant service.

According to an embodiment, the client device 294 (e.g., the smartphone 136 or the AI speaker 137 of FIG. 1) may receive a voice input (for example, a speech) from a user. According to an embodiment, the client device 294 may include a voice recognition module. According to an embodiment, the client device 294 may include a voice recognition module having a limited function. For example, the client device 294 may include a voice recognition module having a function of detecting a designated voice input (for example, a wake-up input such as “Hi, Bixby”) or a function of preprocessing a voice signal acquired from some voice inputs. The client device 294 may be, but is not limited to, an artificial intelligence speaker (an AI speaker). According to an embodiment, a part of the at least one device 295 may be the client device 294.

According to an embodiment, the at least one device 295 (e.g., at least one of the devices 121, 122, and 123 of FIG. 1) may be a target device which performs a particular operation according to a control command from the voice assistant server 250 and/or the IoT server 200. The at least one device 295 may be controlled to perform a particular operation, based on a user voice input received by the client device 294. According to an embodiment, at least a part of the at least one device 295 may receive no control command from the voice assistant server 250 and/or the IoT server 200, and may receive the control command from the client device 294.

The client device 294 may receive a user voice input through a microphone and transmit a voice signal based on the received voice input (or speech data corresponding to the voice input) to the voice assistance server 250.

The voice assistant server 250 may receive a user voice input from the client device 294 and interpret a received voice signal so as to select a target device for performing operations according to the user's intention from among the at least one device 295 and provide, to the IoT server 200 or the target device, information relating to the selected target device and the operations to be performed by the target device.

The IoT server 200 may register and manage information relating to the device 295 for a voice assistant service, and may provide device information for the voice assistant service to the voice assistance server 250. The device information corresponds to information related to a device used to provide the voice assistant service, and may include, for example, at least one of device identification information (device ID information), function performance capability information, location information, or state information. In addition, the IoT server 200 may receive information relating to the target device and the operations to be performed by the target device from the voice assistant server 250, and may provide control information for controlling operations to the target device.

The speech data may be data related to a voice uttered by a user in order to receive the voice assistant service, and data indicating the speech of the user. The speech data may be data used to interpret the user's intention related to an operation the device 295. The speech data may include at least one of a text-type spoken word or a speech parameter having a type of an NLU model (e.g., a first NLU model 262 or a second NLU model 271) output value. The speech parameter corresponds to data output from the NLU model (e.g., the first NLU model 262 or the second NLU model 271), and may include an intent and a parameter. The intent corresponds to information determined by interpreting text by using the NLU model (e.g., the first NLU model 262 or the second NLU model 271), and may indicate the user's intention of speech. The intent may be, for example, information indicating a device operation intended by the user. The intent may include not only information (hereinafter, referred to as “intent information”) indicating the user's intention of speech but also a numeral value corresponding to the information indicating the user's intention. The numerical value may indicate probability at which text is to be related to information indicating a particular type of intention. As a result of interpreting text by using the NLU model, when multiple pieces of information indicating the user's intention are acquired, the intention information having the maximum numerical value corresponding to each piece of intention information may be determined as an intent. In addition, the parameter may be variable information for determining detailed operations of the device, related to the intent. The parameter is information related to the intent, and multiple types of parameters may correspond to a single intent. The parameter may include not only parameter information for determining operation information of the device but also a numerical value indicating the probability at which text is to be related to the corresponding variable information. As a result of interpreting text by using a natural language understanding model, multiple pieces of variable information indicating the parameter may be acquired. In this case, the variable information having the maximum numerical value corresponding to each piece of variable information may be determined as a parameter.

The action data may be data relating to a series of detailed operations of the device 295, which corresponds to predetermined speech data. For example, the action data may include information relating to detailed operations that the device is to perform in response to the predetermined speech data, a correlation between each detailed operation and another detailed operation, and an execution sequence of the detailed operations. The correlation between the detailed operation and another detailed operation includes information relating to another detailed operation to be executed before a detailed operation is executed in order to execute the detailed operation. For example, when the operation to be performed is “music reproduction”, a “power on” operation may be another detailed operation to be executed before a “music reproduction” operation. In addition, the action data may include but is not limited to, for example, functions to be executed by the target device for performing a particular operation, an execution sequence of functions, an input value required to execute functions, and an output value that is output as a result of executing functions.

The device 295 may be, but is not limited to, a smartphone, a tablet PC, a PC, a smart TV, a cellular phone, a personal digital assistant (PDA), a laptop, a media player, a micro server, a global positioning system (GPS) device, an electronic book terminal, a digital broadcasting terminal, a navigation device, a kiosk, an MP3 player, a digital camera, and other mobile or non-mobile computing devices. In addition, the device 295 may be home appliances such as a light, an air conditioner, a TV, a robot vacuum cleaner, a washing machine, a scale, a refrigerator, a set-top box, a home automation control panel, a security control panel, a game console, an electronic key, a camcorder, or an electronic picture frame, which have a communication function and a data processing function. In addition, the device 295 may be a wearable device such as a watch, glasses, a hair band, and a ring, which has a communication function and a data processing function. However, the device 295 is not limited thereto, and the device 295 may include all types of devices which can transmit or receive data to or from the voice assistant server 250 and/or the IoT server 200 through a network.

According to an embodiment, the voice assistant server 250 may include at least one of the communication interface 251 (e.g., the communication interface 131 of FIG. 1), the processor 252 (e.g., the processor 132 of FIG. 1), or the storage 253 (e.g., the storage 133 of FIG. 1), wherein the storage 253 may include at least one of the first voice assistant model 260, at least one second voice assistant model 270, an software development kit (SDK) interface model 280, or a DB 290.

According to an embodiment, the communication interface 251 communicates with at least one of the client device 294, the device 295, or the IoT server 200. The communication interface 251 may directly communicate with the device 295, or may communicate with the device 295, based on relay of the IoT server 200. The communication interface 251 may include one or more components for communicating with the client device 294, the device 295, and the IoT server 200.

In general, the processor 252 controls an overall operation of the voice assistant server 250. For example, the processor 252 may perform a function of the voice assistant server 250 in this disclosure by executing a program (for example, at least one of an application, an instruction, or an algorithm) stored in the storage 253. The processor 252 may operate by using a model stored in the storage 253, and may execute a module stored in the storage 253. In the disclosure, when a predetermined module performs a particular operation, it may mean that an operation defined (or stored) in a module is performed by the processor.

The programs stored in the storage 253 may be classified according to the function thereof, and may be classified into, for example, the first voice assistant model 260, the at least one second voice assistant model 270, the SDK interface model 280, and the like.

According to an embodiment, the first voice assistant model 260 is a model for analyzing a user voice input so as to determine a target device related to a user's intention. The first voice assistant model 260 may include an automation speech recognition (ASR) model 261, a first NLU model 262, a first NLG model 263, a device determination module 264, a function comparison module 265, a speech data acquisition module 266, an action data generation module 267, and a model updater 268.

The ASR model 261 converts text into a voice signal by performing ASR. The ASR model 261 may perform ASR which converts a voice signal into computer-readable text by using a predefined model such as an acoustic model (AM), a language model (LM), or the like. When a voice signal, from which the noise fails to be filtered out, is received from the client device 294, the ASR model 261 may acquire a voice signal by filtering out the noise from the received voice signal, and may perform ASR for the voice signal.

The first NLU model 262 analyzes text and determines, based on the result of the analysis, a first intent related to a user's intention. The first NLU model 262 may be a model trained to acquire the first intent corresponding to the text by interpreting the text. The intent may be information indicating a user's intention of speech included in the text.

The device determination module 264 may determine the user's first intent from the converted text by performing syntactic analysis and/or semantic analysis by using the first NLU model 262. According to an embodiment, the device determination module 264 may parse the converted text in units of morphemes, words, or phrases by using the first NLU model 262, and may infer the meaning of a word extracted from the parsed text by using a linguistic feature (e.g., a syntactic element) of the parsed morpheme, word, or phrase. The device determination module 264 may determine the first intent corresponding to the inferred meaning of a word by comparing the inferred meaning of the word with predetermined intents provided by the first NLU model 262. The device determination module 264 may determine a type of the target device, based on the first intent. The device determination module 264 provides the parsed text and the target device information to the second voice assistant model 270. According to an embodiment, the device determination module 264 may provide identification information (e.g., a device ID) of the determined target device to the second voice assistant model 270 together with the parsed text. The first NLG model 263 may register functions of devices and generate a query message for generating or editing speech data.

For example, the function comparison module 265 may compare a function of the preregistered device 295 with a function of a new device when the new device is registered. The function comparison module 265 may determine whether the function of the preregistered device is identical or similar to the function of the new device. The function comparison module 265 may identify a function identical or similar to that of the preregistered device 295 among functions of the new device.

The function comparison module 265 may identify a name indicating a function supported by the new device from specification information of the new device, and may determine whether the identified name is identical or similar to a name of a function supported by the preregistered device 295. In this case, the DB 290 may store information relating to similar words and a name indicating a predetermined function in advance, and may determine whether the function of the preregistered device 295 is identical or similar to the function of the new device, based on the stored similar word information.

In addition, the function comparison module 265 may determine whether the functions are identical to each other with reference to speech data stored in the DB 290. The function comparison module 265 may determine whether the function of the new device and the function of the preregistered device 295 are identical or similar by using the speech data related to the function of the preregistered device 295. In this case, the function comparison module 265 may interpret the speech data by using the first NLU model, and may determine whether the function of the new device is identical or similar to the function of the preregistered device 295, based on meanings of words included in the speech data.

The function comparison module 265 may determine whether a single function of the preregistered device 295 is identical or similar to a single function of the new device. The function comparison module 265 may determine whether a function set of the preregistered device 295 is identical or similar to a function set of the new device.

The speech data acquisition module 266 may acquire the speech data related to the function of the new device. The speech data acquisition module 266 may extract, from a speech data DB 291, speech data corresponding to a function that is determined to be identical or similar to the function of the new device among functions of the preregistered device 295.

The speech data acquisition module 266 may extract, from the speech data DB 291, speech data corresponding to a function set that is determined to be identical or similar to the function set of the new device among function sets of the preregistered device 295. In this case, the speech data corresponding to the function of the preregistered device 295 and the speech data corresponding to the function set of the preregistered device 295 may be stored in the speech data DB 291 in advance.

The speech data acquisition module 266 may edit a function and a function set that are determined to be identical or similar, and may generate the speech data corresponding to the edited functions. The speech data acquisition module 266 may combine functions determined to be identical or similar, and may generate speech data corresponding to the combined functions. In addition, the speech data acquisition module 266 may combine a function and a function set that are determined to be identical or similar, and may generate speech data corresponding to the combined functions. In addition, the speech data acquisition module 266 may delete some functions among functions in the function set that is determined to be identical or similar, and may generate speech data corresponding to the function set from which some functions are deleted.

The speech data acquisition module 266 may extend speech data. The speech data acquisition module 266 may generate similar speech data having the same meaning as but having different expressions from extracted or generated speech data by revising an expression of the extracted or generated speech data.

The speech data acquisition module 266 may output a query for registering an additional function and for generating or editing speech data, by using the first NLG model 263. The speech data acquisition module 266 may provide, to the user device 295 or a developer device (not shown), guidance text or guidance voice data for registering a function of a new device and guiding speech data generation. The speech data acquisition module 266 may provide, to the user device 295 or the developer device (not shown), a list of functions different from the function of the preregistered device 295, among functions of the new device. The speech data acquisition module 266 may provide, to the user device 295 or the developer device (not shown), recommended speech data related to at least some of the different functions.

The speech data acquisition module 266 may interpret a response to the query by using the first NLU model 262. The speech data acquisition module 266 may generate speech data related to functions of the new device, based on the interpreted response. The speech data acquisition model 266 may generate speech data related to the functions of the new device by using the interpreted response of the user or the interpreted response of the developer, and may recommend the generated speech data. The speech data acquisition module 266 may select some of the functions of the new device, and may generate speech data related to each of some selected functions. The speech data acquisition module 266 may select some of the functions of the new device, and may generate speech data related to a combination of some selected functions. The speech data acquisition module 266 may generate speech data related to the function of the new device by using the first NLG module 263, based on identification values and attributes of the functions of the new device.

The action data generation module 267 may generate action data for the new device, based on the same or similar functions and speech data. For example, when there is a single function corresponding to the speech data, the action data generation module 267 may generate action data including a detailed operation indicating the single function. For example, when a function corresponding to the speech data is a function set, the action data generation module 267 may generate detailed operations indicating the functions in the function set or an execution sequence of the detailed operations. The action data generation module 267 may generate action data by using speech data generated in relation to a new function of the new device. The action data generation module 267 may generate action data corresponding to the generated speech data by identifying new functions of the new device, which are related to the speech data, and determining an execution sequence of the identified functions. The generated action data may be matched to the speech data and the similar speech data.

The model updater 268 may generate or update the second voice assistant model 270 related to the new device by using the speech data and the action data. The model updater 268 may generate or update the second voice assistant model 270 related to the new device by using the speech data corresponding to the function of the preregistered device 295 related to the function of the new device, the speech data newly generated in relation to the function of the new device, the extended speech data, and the action data. The model updater 268 may accumulatively store the action data and the speech data related to the new device in the speech data DB 291 and the action data DB 292. In addition, the model updater 268 may generate or update a concept action network (CAN) that is a capsule-type database included in an action plane management model 273.

The second voice assistant model 270 is a model specialized in a particular device, and may determine an operation to be performed by the target device in response to a voice input from the user. The second voice assistant model 270 may include the second NLU model 271, the second NLG model 272, and the action plan management model 273. The voice assistant server 250 may include the second voice assistant model 270 for each device type.

The second NLU model 271 is an NLU model specialized in a particular device, and may analyze text and determine, based on the result of the analysis, a second intent related to the user's intention. The second NLU model 271 may interpret the input voice from the user in consideration of the function of the device. The second NLU model 271 may be a model trained to analyze text and acquire the second intent corresponding to the text.

The second NLG model 272 is an NLG model specialized in a particular device, and may generate a query message required to provide a voice assistant service to the user. The second NLG model 272 may generate a natural language for a conversation with the user in consideration of the function of the device.

The action plan management model 273 is a model specialized in a device, and may be a model for determining an operation to be performed by the target device in response to the voice input from the user. The action plan management model 273 may plan operation information to be performed by the new device in consideration of the function of the new device.

The action plan management model 273 may select detailed operations to be performed by the new device from the interpreted speech voice of the user, and may plan an execution sequence of the selected detailed operations. The action plan management model 273 may acquire operation information relating to the detailed operation to be performed by the new device, by using the result of the planning. The operation information may be information related to detailed operations to be performed by the device, a correlation between detailed operations, and an execution sequence of the detailed operations. The operation information may include but is not limited to, for example, functions to be performed by the new device for performing detailed operations, an execution sequence of the functions, an input value required to execute the functions, and an output value that is output as a result of the execution of the functions.

The action plan management model 273 may manage information relating to multiple detailed operations of the new device and a relation between the multiple detailed operations. A correlation between each of the multiple detailed operations and another detailed operation may include information relating to another detailed operation to be mandatorily performed before one detailed operation is executed in order to execute the detailed operation.

The action plan management model 273 may include a concept action network (CAN) that is a capsule-type database indicating operations of the device and a correlation between the operations. The CAN may include functions to be executed by a device for performing a particular operation, an execution sequence of the functions, an input value required to execute the functions, and an output value that is output as a result of the execution of the functions, and may be implemented in an ontology graph including knowledge triples indicating a concept and a relation between concepts.

The SDK interface module 280 may transmit or receive data to or from the client device 294 or a developer device (not shown) through the communication interface 251. The client device 294 or the developer device (not shown) may install a predetermined SDK for registering a new device, and may receive a GUI from the voice assistant server 250 through the installed SDK. The processor 252 may register a function of the new device, and may provide a GUI for speech data generation to a user device 295 or a developer device (not shown) through the SDK interface model 280. The processor 252 may receive a response input from the user through the GUI provided to the user device 295, from the user device 295 through the SDK interface model 280, or may receive a response input from a developer through the GUI provided to the developer device (not shown), from the developer device (not shown) through the SDK interface model 280. The SDK interface model 280 may transmit or receive data to or from the IoT server 200 through the communication interface 251.

The DB 290 may store various types of information for a voice assistant service. The DB 290 may include the speech data DB 291 and the action data DB 292.

The speech data DB 291 may store speech data related to functions of the client device 294, the device 295, and the new device.

The action data DB 292 may store action data related to functions of the client device 294, the device 295, and the new device. The speech data stored in the speech data DB and the action data stored in the action data DB 292 may be mapped to each other.

According to an embodiment, the IoT server 200 (e.g., the first IoT sever 110 of FIG. 1) may include at least one of a communication interface 210 (e.g., the communication interface 111 of FIG. 1), a processor 220 (e.g., the processor 112 of FIG. 1), or a storage 230 (e.g., the storage 113 of FIG. 1). The storage 230 may include at least one of a protocol conversion module 231, a data broker module 232, a device management module 233, an authentication module 234, an AI learning module 235, an AI performing module 236, an application execution module 237, an application and data management module 238, an API 239, or a DB 240.

As described above, the IoT server 200 may transfer a control command to the device 295 when the connected device 295 is determined to be a target device. FIG. 2 shows that the IoT sever 200 and the device 295 transmit or receive data without relay of a node, but it is illustrative, and data may be transmitted or received according to the relay of the node as described in FIG. 1.

According to an embodiment, when information on and/or a control command for the target device is acquired from the voice assistant server 250, the processor 220 may transmit the control command from the target device through the communication interface 210. Alternatively, the processor 220 may acquire the information on and/or the control command for the target device from another source other than the voice assistant server 250, or may acquire the information and/or the control command for the target device, based on detection of a pre-designated condition. As described above, the processor 220 may provide a control command to the target device by executing, for example, an automation application, but a provision scheme is not limited.

According to an embodiment, the protocol conversion module 231 may be referred to as a device-type handler module, and may implement, for example, a device-type handler obtained by abstracting a device from a unique capability of the device. More specifically, the device-type handler allows creation of an automation application for a command and a state of the device by using a generalized or normalized language. The protocol conversion module 231 may convert the generalized language into a language specified for a device. The protocol conversion module 231 may receive an event and a state specified for the device, and may provide a generalized event and state so that the data broker module 232 can use the same. The protocol conversion module 231 may receive a generalized command from the data broker module 232 and convert the generalized command into a command specified for the device so that the same can be transferred to the device.

According to an embodiment, the data broker module 232 may receive event data from the outside (e.g., a node or the voice assistant server 250) through the communication interface 210, and may determine a scheme by which the event data is to be routed in a system. The data broker module 232 may be referred to as an event processing and routing module.

According to an embodiment, the device management module 233 may register and manage information relating to the device 295. For example, the device information may include at least one of device identification information (device ID information), function performance capability information, location information, or state information.

According to an embodiment, the authentication module 234 may perform at least one of identification, registration, or authentication of the device 295. The authentication module 234 may also perform authentication of access from the outside. The authentication module 234 may also perform authentication of another IoT server when another IoT server is connected.

According to an embodiment, for example, the AI learning module 235 may perform learning based on learning data stored in the DB 240, and may generate an AI model as a result of the learning. For example, the target device information and the control command from the voice assistant server 250 and the device information at the time of performing the control command may be associated and stored in the DB 240. The AI learning module 235 may perform machine learning for information so as to generate an AI model which can output a corresponding target device and a corresponding control command when, for example, device information is input. The AI performing module 236 may input the device information into the AI model and identify the target device and the control command from the AI model. Accordingly, even without involvement of the voice assistant server 250, the IoT server 200 may control the device 295, based on the device information. For example, the AI model may be independently managed from an automation application, and may be implemented so that the automation application is to be updated based on the AI model according to implementation. Alternatively, the AI model may be implemented to be added as an instance of the automation application. When the AI model is included as a part of the automation application, or is used for updating, the AI performing module 236 may be included in or omitted from the application execution module 237.

According to an embodiment, the application execution module 237 may execute the automation application. The application and data management module 238 may manage a history of execution of the automation application, for example, data of an event or an action, and may store or delete the same in or from the DB 240. As described above, the API 239 may configure a web-based interface, or may be used for exposing a resource to the outside (e.g., an API end-point). The DB 240 may store at least one of information associated with the automation application, information relating to the device, a physical graph, or the AI model.

FIG. 3 illustrates an IoT server and an edge computing system according to various embodiments. At least a part of a component of FIG. 3 may be omitted, or a component that is not shown may be further included.

Referring to FIG. 3, according to an embodiment, an edge computing system 300 (e.g., the node 120 of FIG. 1) may communicate with an IoT server 200 (e.g., the first IoT server 110 of FIG. 1) and devices 351, 352, and 353 (e.g., devices 121, 122, and 123). The edge computing system 300 may be disposed in, for example, a local environment, that is, an area in which the devices 351, 352, and 353 are disposed (or located). The edge computing system 300 may transfer a control command to a target device by determining the target device so that an action corresponding to event detection is to be performed. For example, the edge computing system 300 may transfer the control command to the target device, based on an automation application and/or an AI model. The edge computing system 300 and the devices 351, 352, and 353 may be directly connected without a relay device, and thus, when the control command of the target device is performed, latency can be reduced in comparison a case in which a central server (e.g., the IoT server 200) is involved. Further, since determination of the target device and the control command may be performed in a local area, an operation of the central server (e.g., the IoT server 200) can be distributed. Furthermore, information relating to an event may not be provided to the central server (e.g., the IoT server 200), and thus user privacy can be enhanced.

According to an embodiment, the edge computing system 300 may include at least one of a first communication interface 311, a second communication interface 312, a processor 320, or a storage 330. The storage 330 may include at least one of a protocol conversion module 331, a data broker module 332, a device management module 333, an authentication module 334, an AI performing module 336, an application execution module 337, an application and data management module 338, an API 339, or a DB 340.

According to an embodiment, the first communication interface 311 may communicate with the devices 351, 352, and 353 in the local area. As described above, the first communication interface 311 may include at least one communication module for supporting short-range communication such as at least one of Bluetooth, Wi-Fi, Wi-Fi direct, Z-wave, Zig-bee, INSTEON, X10, or infrared data association (IrDA). The second communication interface 312 may communicate with, for example, the IoT server 200. The second communication interface 312 may include at least one communication module for supporting long-range communication such as the Internet or a computer network (e.g., LAN or WAN).

Each operation of the processor 320, the protocol conversion module 331, the data broker module 332, the device management module 333, the authentication module 334, the AI performing module 336, the application execution module 337, the application and data management module 338, the API 339, or the DB 340 may be substantially similar to each operation of the processor 220, the protocol conversion module 231, the data broker module 232, the device management module 233, the authentication module 234, the AI performing module 236, the application execution module 237, the application and data management module 238, the API 239, or the DB 240 of the IoT server 200. FIG. 3 illustrates that the edge computing system 300 includes no AI learning module. The edge computing system 300 may receive an AI model from the IoT server 200, and may identify a target device and a control command, based on the received AI model. The edge computing system 300 may be implemented to provide information relating to a pre-performed event-specific action to the IoT server 200 for AI learning, or not to provide the same for privacy protection. According to another embodiment, the edge computing system 300 may also include the AI learning module, and in this case, the edge computing system 300 may directly generate an AI model based on the information relating to the pre-performed event-specific action.

FIG. 4 is a flow chart illustrating an operation between clouds according to an embodiment.

Referring to FIG. 4, a cloud-cloud service system may include an application (or a client) 401, an origin cloud 402, a target cloud 403, and a device (or a server) 404. For example, an operation of the cloud-cloud service system may follow the standard suggested by the Open Connectivity Foundation (OCF), but it is illustrative, and the operation thereof is not limited. In FIG. 4, an operation of the application 401 may be, for example, an operation of the device 124 of FIG. 1, an operation of the origin cloud 402 may be, for example, an operation of the first IoT server 110 of FIG. 1, an operation of the target cloud 403 may be, for example, an operation of the second IoT serer 140 of FIG. 1, and an operation of the device 404 may be, for example, an operation of at least one the devices 151, 152, and 153 of FIG. 1.

According to an embodiment, in operation 411, the origin cloud 402 and the target cloud 403 may identify each other's URI (or URL). For example, at least one entity in the cloud-cloud service system may perform device and/or cloud provision based on a mediator. Here, for example, the mediator is a logical function defined in the OCF standard, and may be an application from a cloud service provider. The mediator may be configured to perform an out-of-band process so as to acquire an URI (or URL) of the cloud. In operation 413, the origin cloud 402 and the target cloud 403 may set up security connection (for example, a transport layer security (TSL) session). In operation 415, the device 404 may perform device on-boarding on the target cloud 403. Here, for example, the device on-boarding may mean a procedure of registering the device 404 in the target cloud 403, and the scheme thereof is not limited.

In operation 417, the application 401 may perform initial association with the origin cloud 402 and the target cloud 403. The initial association procedure may include, for example, an authentication processor and/or an authority configuration process. For example, when the application 401 receives a request for a link connection (link account) with the target cloud 403, an operation of requesting an URL open from the origin cloud 402 may be included. The initial association procedure may include an operation of generating and storing a state query parameter, initiating an authentication procedure (e.g., an OAuth process), and redirecting an authentication service of the target cloud 402, by the origin cloud 402. The initial association procedure may include an operation of redirecting to the authentication server of the target cloud 402 and providing an authentication UI, based on information from the authentication server, by the application 401. The initial association procedure may include an operation of receiving an input of a credential of the target cloud 402 with respect to the authentication UI, providing a user credential to the authentication server, providing an agreement screen, based on information from the authentication server, and providing authorization to an authentication application of the origin cloud 402 to the authentication server. The initial association procedure may include an operation of receiving an authority code through redirecting from the authentication server in response to the authorization, and an operation of performing redirecting, by the application 401. The initial association procedure may include an operation of verifying a state query parameter by the origin cloud 402, an operation of exchanging the authority code with the authentication server and refreshing a token, an operation of returning back the token from the authentication server, and an operation of performing access association and token refreshing by using a user ID of the origin cloud 402. The above-described procedure is a simple example, and those skilled in the art will understand that at least a part of the procedure can be omitted, or another procedure can be added.

In operation 419, the origin cloud 402 and the target cloud 403 may perform a device and resource discovery procedure. For example, the device and resource discovery procedure may mean a series of procedures of discovering, by the origin cloud 402, a provided resource, and a device connected to the target cloud 403. For example, the device and resource discovery procedure may include an operation of transmitting a device information request message (e.g., GET https://devices) including an access token to the target cloud 403 by the origin cloud 402. The device and resource discovery procedure may include an operation of transmitting a message (e.g., 200 OK) including information relating to devices hosted by the target cloud 403 to the origin cloud 402, by the target cloud 403, as a response.

In operation 421, the application 401 may request a resource control from the origin cloud 402. For example, the resource control may include at least one of control of a device connected to the target cloud 403, acquisition of information from the device, or use of a resource provided by the target cloud 403, but is not limited in type. For example, the application 401 may transmit a message of POST coaps://deviceid/resourcehref to the origin cloud 402. The message may include a device identifier (deviceid) and a link parameter (resourcehref), but is not limited thereto. A payload may be defined by the OCF for an update of a resource type (RT). Those skilled in the art will understand that the application 401 may request a resource control, based on a scheme other than a CoAP scheme. In operation 423, the origin cloud 402 may request a resource control from the target cloud 403. For example, the origin cloud 402 may transmit a message of POST coaps://deviceid/resourcehref to the target cloud 403. In operation 425, the target cloud 403 may request a resource control from the device 404. For example, the target cloud 403 may transmit a message of POST coaps://resourcehref to the device 404 corresponding to, for example, deviceid. For example, in response to the message of POST coaps://resourcehref, the device 404 may transmit a 2.05 response message. The target cloud 403 may transmit the 2.05 response message to the origin cloud 402, and the origin cloud 402 may transmit the 2.05 response message to the application 401.

In operation 427, the application 401 may request observation (observer). For example, the application 401 may request observation of an event at the device 404, and the observation may be requested by a user's manipulation (or satisfaction of another condition). The observation of the event is a simple example, and those skilled in the art will understand that, in addition to the observation request, a control of the device 404 through the application 401 is also possible. For example, the application 401 may transmit a message of GET coaps://deviceid/resourcehref to the origin cloud 402. For example, the message may include information indicating the observation request (e.g., observe=0(register)). The origin cloud 402 may request event subscription from the target cloud 403 in operation 429. For example, the origin cloud 402 may transmit a message of POST https://devices/resourcehref/subscriptions to the target cloud 403. The message may include but is not limited to, for example, at least one of an event type (for example, a type in which a resource content changes), an event URL (for example, https://eventsurl), or a signing secret. The target cloud 403 may transmit a message of 200 OK to the origin cloud 402. The message may include a subscription identifier (subscription-ID) (for example, UUID). The target cloud 403 may transmit a message (e.g., GET coaps://resourcehref) requesting subscription registration, to the device 404. The device 404 may transmit a 2.05 response message for identifying the subscription registration to the target cloud 403 in response thereto. The message may include at least one of information indicating the subscription registration (e.g., observe=0) or a device identifier. The target cloud 403 may calculate an HMAC-SHA256 signature by using the signing secret. The target cloud 403 may transmit a message of Post https://eventsurl to the origin cloud 402. The message may include, for example, at least one of a subscription identifier (e.g., UUID), a sequence number, an event type, or an event signature. The origin cloud 402 may transmit a message of 200 OK to the target cloud 403 in response thereto. The origin cloud 402 may authenticate the event signature. The origin cloud 402 may calculate the HMAC-SHA256 signature and compare the same with the received information. The origin cloud 402 may transmit a 2.05 identification message to the application 401, and the message may include information indicating registration of the subscription.

In operation 431, the target cloud 403 may identify occurrence of the event from the device 404. In operation 433, the target cloud 403 may inform the origin cloud 402 of the event, and in operation 435, the origin cloud 402 may inform the application 401 of the event. For example, a case in which an event has occurred in the device 404 is assumed. For example, the device 404 may transmit a 2.05 response message to the target cloud 403. The message may also include information relating to the event. The target cloud 403 may calculate the HMAC-SHA256 signature by using the signing secret. The target cloud 403 may transmit a message of Post https://eventsurl to the origin cloud 402. The message may include, for example, at least one of a subscription identifier (e.g., UUID), a sequence number, an event type, or an event signature. The origin cloud 402 may transmit a message of 200 OK to the target cloud 403 in response thereto. The origin cloud 402 may authenticate the event signature. The origin cloud 402 may calculate the HMAC-SHA256 signature and compare the same with the received information. The origin cloud 402 may transmit a 2.05 identification message to the application 401, and the message may include information relating to the event.

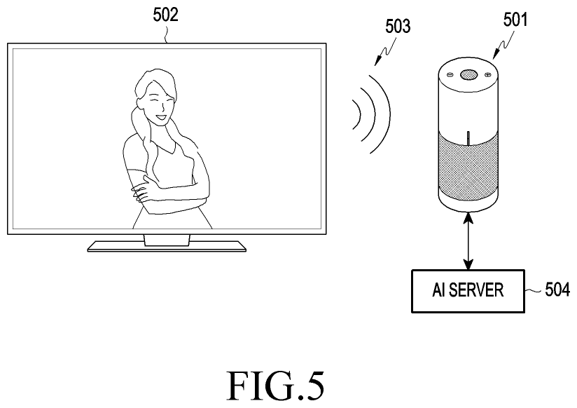

FIG. 5 illustrates an electronic device, a media device, and an AI server according to an embodiment. According to an embodiment, an electronic device 501 may include a microphone and a speaker such as the AI speaker 137 of FIG. 1. The microphone of the electronic device 501 may convert a voice from the outside of the electronic device 501, that is, a vibration of air, into voice data which is an electrical signal. The electronic device 501 may recognize a trigger voice, based on the voice data. For example, the trigger voice is a voice configured to initiate a voice recognition service, and may be configured to be text (e.g., “Hi, Bixby”) devised for voice recognition service provision. The electronic device 501 may identify whether the text corresponding to the trigger voice is detected, and the recognition of the trigger voice in this disclosure may be understood as recognition of the text corresponding to the trigger voice.

According to an embodiment, when the trigger voice is recognized, the electronic device 501 may output a response voice through a speaker in response to the recognized trigger voice. The electronic device 501 may operate based on voice data additionally input through the microphone after the response voice. For example, the electronic device 501 may transfer the voice data to the AI server 503 (e.g., the voice assistant server 130 of FIG. 1), and the AI server 503 may process the voice data to perform a corresponding operation. Alternatively, the electronic device 501 may transfer an instruction acquired by recognizing the voice data to the AI server 503, and the AI server 503 may process the instruction. According to implementation, the electronic device 501 may also process the voice data (or may transmit the voice data to the AI server 503, and/or may transmit the instruction acquired by recognizing the voice data to the AI server 503), without the trigger voice. In addition, FIG. 5 shows that the electronic device 501 transmits the voice data and/or the instruction to the AI server 503, but it is a simple example, and the electronic device 501 may transmit the voice data and/or the instruction to an IoT server (e.g., the IoT server 110) or at least one device (e.g., the devices 121, 122, and 123) connected to a home network, and the at least one device may perform an operation corresponding to the voice data and/or the instruction. FIG. 5 illustrates the electronic device 501 as an AI speaker, but it is a simple example, and those skilled in the art will understand that there is no limitation if the electronic device 501 is a device which can process a voice and perform a corresponding operation.

According to an embodiment, the media device 502 may output content corresponding to a media file. As shown in FIG. 5, the media device 502 may output both a voice 503 and a screen through a display, and in this case, the content may be video content including both a screen and a voice 503. Those skilled in the art will understand that there is no limitation in the type of the media file if the media file can provide content including a voice. In addition, there is no limitation in the type of the media device 502 if the media device corresponds to not only a TV but also a device which can output content including a voice as shown in FIG. 5.

As shown in FIG. 5, the voice 503 output from the media device 502 may be converted into voice data by the electronic device 501. When the voice 503 output from the media device 502 includes a trigger voice (e.g., “Hi, Bixby”), the electronic device 501 may detect the trigger voice from the converted voice data. The electronic device 501 may process an additional voice after the trigger voice. When the additional voice includes a command for purchasing a particular article, the electronic device 501 and/or the AI server 503 may perform the purchase command corresponding to the additional voice. For example, the electronic device 501 may transmit a request for processing the additional voice to the AI server 503, and the AI server 503 may recognize the purchase command and operate an operation corresponding to the purchase command by processing the additional voice. Alternatively, the electronic device 501 may directly recognize the purchase command from the additional voice and directly perform an operation corresponding to the purchase command.

According to the disclosure, the media device 502 may identify whether the output voice 503 includes a trigger voice and/or a command. When the output voice 503 includes the trigger voice or the command, the electronic device 501 may be informed of the same. When it is identified that the output voice 503 includes the trigger voice and/or the command, the electronic device 501 may skip the processing of the trigger voice and/or the command, or may inquire of whether to process the same.

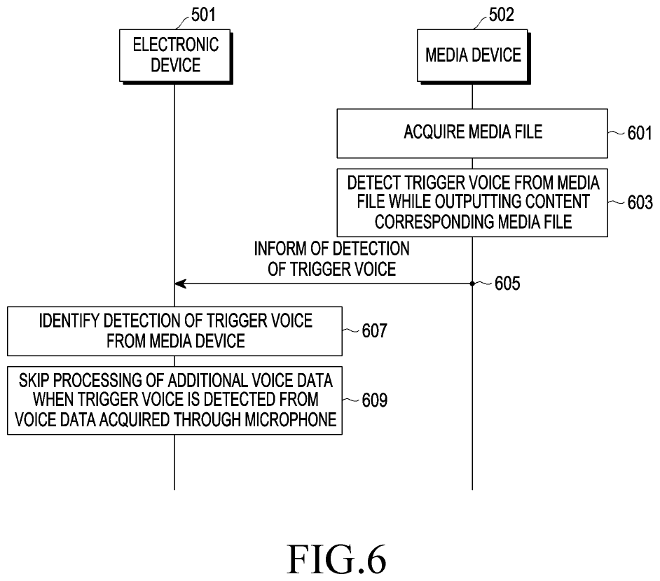

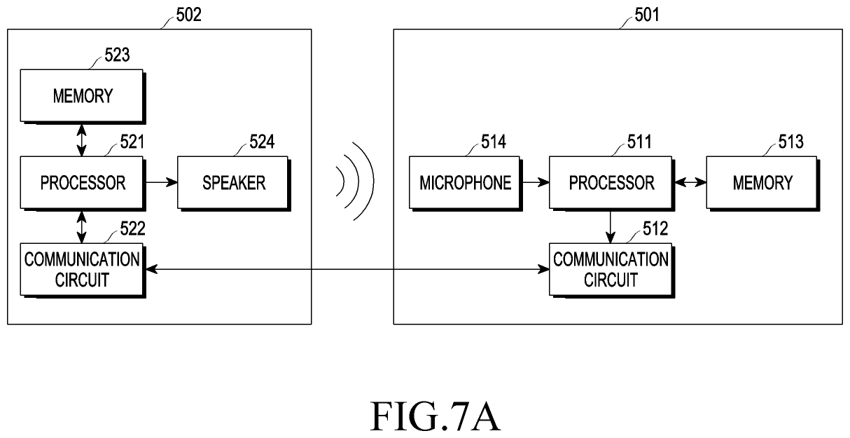

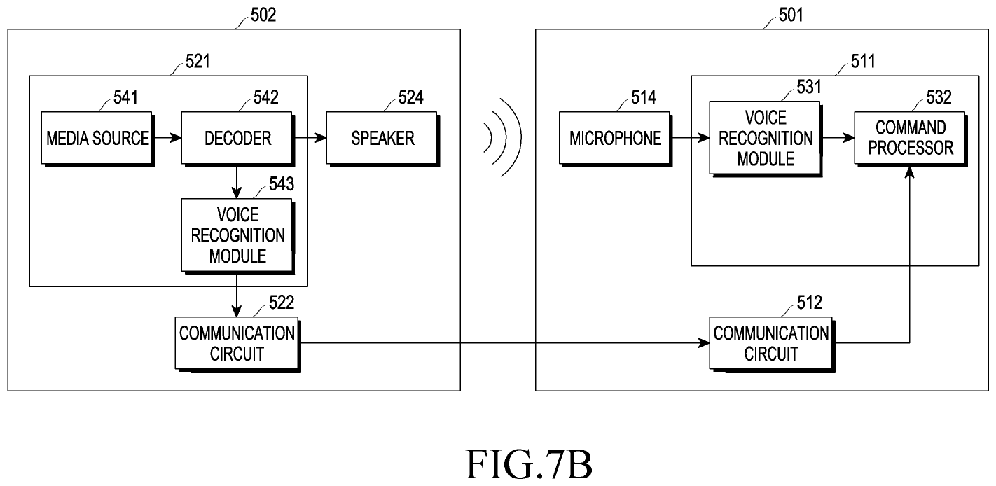

FIG. 6 is a flow chart illustrating a method for operating an electronic device and a media device according to an embodiment. An embodiment of FIG. 6 is described with reference to FIG. 7A. FIG. 7A is a block diagram illustrating an electronic device and a media device according to an embodiment. In the disclosure, when an electronic device 501 and/or a media device 502 performs a particular operation, it may mean that a processor 511 and/or a processor 521 included in the electronic device 501 and/or a media device 502, respectively, performs the particular operation, or controls another hardware to perform the particular operation. Alternatively, when the electronic device 501 and/or the media device 502 performs a particular operation, it may mean that an instruction stored in a memory 513 and/or a memory 523 is executed and the processor 511 and/or the processor 521 performs the particular operation, or controls another hardware to perform the particular operation. Alternatively, when the electronic device 501 and/or the media device 502 performs a particular operation, it may mean that an instruction for performing the particular operation is stored in the memory 513 and/or the memory 523.

According to an embodiment, the media device 502 may acquire a media file in operation 601. The processor 521 of the media device 502 may acquire a media file. For example, the processor 521 of the media device 502 may load a media file (e.g., a sound source file or a video file) stored in the memory 523 in advance. FIG. 7A illustrates that the memory 523 is included in the media device 502, but according to implementation, the memory 523 may be implemented as a detachable storage means (e.g., a USB storage or an external hard drive) to be wiredly or wirelessly connected to the media device 502. The media device 502 may identify a command for reproducing a particular media file (for example, selection on an icon corresponding to a particular media file), and may load the media file, based on the identification. In another embodiment, the media device 502 may stream a media file in real time. For example, the media device 502 may receive multiple packets including data for reproducing content, through a communication circuit 522, or may receive broadcasting data through a broadcasting signal reception module (not shown). The received data may be stored in a buffer (e.g., a buffer in the memory 523 or a buffer external to the memory 523), and the processor 521 may load the stored data. The acquisition of a media file in the disclosure may include loading of a prestored media file and/or loading of data acquired through the communication circuit 522 as described above, and those skilled in the art will understand that there is no limitation thereto.

According to an embodiment, in operation 603, the media device 502 may output content corresponding to the media file and detect a trigger voice from the media file. For example, the processor 521 may detect a trigger voice, for example, text corresponding to the trigger voice, based on a signal obtained by decoding the media file. For example, the processor 521 may acquire an encoded media file, and may decode the encoded media file for content output. The processor 521 may transfer the decoded signal to a speaker 524, and may output a voice corresponding to the decoded signal. When the media file is a video file, those skilled in the art will understand that the processor 521 may control output of a screen based on the video file through a display (not shown). The processor 521 may perform voice recognition based on the decoded signal. For example, the processor 521 may perform ASR for the decoded signal and identify text corresponding to the decoded signal. The processor 521 may identify whether the identified text includes the text corresponding to the trigger voice. The processor 521 may detect whether the trigger voice is included in an output voice, based on the comparison of the described text. When the decoded media file is directly acquired, the processor 521 may identify whether the trigger voice is detected, based on the media file without a separate decoding process.

According to an embodiment, in operation 605, the media device 502 may inform the electronic device 501 of detection of the trigger voice. For example, the processor 521 of the media device 502 may transmit a communication signal including information indicating detection of the trigger voice through the communication circuit 512 of the electronic device 501, through the communication circuit 522. Since the electronic device 501 may skip processing of additional voice data by the corresponding communication signal, the communication signal may be referred to as a ignore command. FIG. 7A illustrates that the electronic device 501 directly transmits a communication signal without a separate relay device, but it is illustrative, and at least one relay device may perform transmission or reception of a communication signal between the media device 502 and the electronic device 501. For example, in a case of P2P communication such as Bluetooth-based communication, Wi-Fi direct, Z-wave, Zig-bee, INSTEON, X10, UWB, or infrared data association (IrDA), the communication circuit 522 may transmit a communication signal including information indicating detection of the trigger voice to the communication circuit 512 of the electronic device 501 without a relay device. It is assumed that there is pairing (or connection) formed already between communication circuits 512 and 522. Alternatively, when the communication circuit 522 goes through Wi-Fi communication, the communication circuit 522 may transmit a communication signal including information indicating detection of the trigger voice to the communication circuit 512 of the electronic device 501 through at least one access point (not shown). Alternatively, the communication circuit 522 may transmit a communication signal including information indicating detection of the trigger voice to the communication circuit 512 through network communication (e.g., Internet communication).

According to an embodiment, in operation 607, the electronic device 501 may identify that the trigger voice has been detected by the media device 502. The processor 511 of the electronic device 501 may identify information indicating detection of the trigger voice from the communication signal received through the communication circuit 512. In operation 609, when the trigger voice is detected from voice data acquired through the microphone 514, the electronic device 501 may skip processing of additional voice data. The voice 503 output from the speaker 524 of the media device 502 may be, for example, a corpus of “Hi, Bixby”. The processor 521 of the media device 502 may identify that a media file (e.g., a signal obtained by decoding the media file) for outputting “Hi, Bixby” includes text of “Hi, Bixby” corresponding to the trigger voice. The processor 521 of the media device 502 may transmit a communication signal indicating detection of the trigger voice to the electronic device 501. The processor 511 of the electronic device 501 may identify that a voice indicating detection of the trigger voice has been output from the media device 502, based on the communication signal received through the communication circuit 512. In addition, the processor 511 may receive, from the microphone 514, voice data obtained by converting the voice 503 generated from the outside. The processor 511 may perform ASR for the voice data to identify text of “Hi, Bixby”. The processor 511 may identify that the voice 503 acquired through the microphone 514 includes a trigger voice, that is, “Hi, Bixby”. The processor 511 may ignore the trigger voice in the voice 503 acquired through the microphone 514, based on output of the trigger voice from the media device 502. For example, when the trigger voice is included in the voice 503 acquired through the microphone 514, the processor 511 may be configured to output a response voice of “What can I do for you?”. However, the processor 511 may not output the response voice, based on output of a voice indicating detection of the trigger voice from the media device 502. Even though additional voice data is acquired, the processor 511 may not process the corresponding voice data. Alternatively, the processor 511 may output a voice (e.g., Another device calls me, right?) indicating that an external electronic device is calling the processor 511 itself and may not process additional voice data. When a command for processing additional voice data is recognized later from the additional voice data from a user, the processor 501 may process the additional voice data.

According to an embodiment, the processor 511 may identify a first time point in which output of a trigger voice from the media device 502 is identified and a second time point in which it is identified that voice data acquired through the microphone 514 includes a trigger voice, based on the received communication signal 512. When a difference between the first time point and the second time point satisfies a pre-designated condition (for example, when a difference between the first time point and the second time point has a value smaller than a threshold), the processor 511 may be configured not to process additional voice data after the trigger voice. The threshold may be configured in consideration of at least one of a time required to perform voice recognition by the media device 502, a time required to generate a communication signal, a time required to transmit or receive the communication signal, a time required to identify information from the communication signal by the electronic device 501, or a time required to recognize a trigger voice by the electronic device 501, but a factor used for the corresponding configuration is not limited. Accordingly, when a user utters a trigger voice after a predetermined time passes since the trigger voice is output from the media device 502, the electronic device 501 may operate in response to the trigger voice from the user. The condition by the first time point and the second time point is a simple example, and those skilled in the art will understand that the condition may be substituted by a condition including at least one of time points indicated while the electronic device 501 recognizes the trigger voice, and time points identified while the electronic device 501 identifies information from the communication signal from the media device 502.

In an embodiment, when recognizing both the trigger voice and the command, the processor 511 may be configured to skip processing of a voice detected after the trigger voice. For example, it is assumed that the media device 502 outputs a voice of “Hi, Bixby, buy one soccer ball” which is a corpus. For example, the processor 511 may perform ASR for voice data so as to identify text of “Hi, Bixby, buy one soccer ball” which is a corpus. The processor 511 may identify that the trigger voice of “Hi, Bixby” is included in a voice 503 acquired through the microphone 514. The processor 511 may determine whether to process a command in the text of “buy one soccer ball” following the trigger voice of “Hi, Bixby”, according to whether the trigger voice is output from the media device 502. For example, the media device 502 may identify that an output voice of “Hi, Bixby, buy one soccer ball” includes the trigger voice, and may inform the electronic device 501 of the detection of the trigger voice through the communication circuit 522. When it is identified that the trigger voice has been output from the media device 502, the processor 511 may skip processing of “buy one soccer ball” following the trigger voice of “Hi, Bixby”. When it is not identified that the trigger voice has been output from the media device 502, the processor 511 may perform processing of “buy one soccer ball” following the trigger voice of “Hi, Bixby”. For example, the processor 511 may request processing of “buy one soccer ball” from the AI server 504, and the AI server 504 may perform a command corresponding to “buy one soccer ball” by performing an e-commerce purchase for a soccer ball. Alternatively, the processor 511 may recognize “buy one soccer ball” and generate a purchase command, and may also transmit the purchase command to the AI server 504 (or an e-commerce-associated external device).

According to an embodiment, the processor 511 and/or the processor 521 may be implemented in a combination of one or more of a general-purpose processor such as a central processing unit (CPU), a digital signal processor (DSP), an application processor (AP), and a communication processor (CP), a graphics-dedicated processor such as a graphics processing unit (GPU) and a vision processing unit (VPU), or an artificial intelligence-dedicated processor such as a neural processing unit (NPU). The communication circuit 512 and/or the communication circuit 522 may be implemented as a communication module or a set of communication modules for supporting at least one of the above-described various communication schemes, and each of the communication circuit 512 and the communication circuit 522 may be implemented in one or more hardware devices. The memory 513 and/or the memory 523 may include at least one type of storage medium of a flash memory type memory, a hard disk type memory, a multimedia card micro type memory, and a card type memory (for example, an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk, and is not limited in type. The memory 513 and/or the memory 523 may store at least one instruction causing an operation to be performed in the disclosure. The memory 513 and/or the memory 523 may store an algorithm (or a model) for detecting ASR and/or a trigger voice.

FIG. 7B is a block diagram illustrating an electronic device and a media device according to an embodiment.

Referring to FIG. 0.7B, the processor 521 of the media device 502 may include at least one of a media source 541, a decoder 542, or a voice recognition module 543. The processor 511 of the electronic device 501 may include at least one of a voice recognition module 531 or a command processor 532. In the disclosure, when the processor 511 and/or the processor 521 includes a component (e.g., the command processor 532, the media source 541, the decoder 542, or the voice recognition module 531 or 543), it may mean that the corresponding hardware is included in a system on chip (SoC) of the processor 521, or it may mean that software for performing an operation of the corresponding component is loaded and operated by the processor 521.

According to an embodiment, the media source 541 of the media device 502 may acquire a media file. For example, the media source 541 may mean but is not limited to a program and/or hardware for loading a media file. Alternatively, the media source 541 may mean a source for providing a media file, and this case, the media source 541 may mean a storage means or a communication circuit, wherein the media source 541 may be located outside the processor 521.

According to an embodiment, the decoder 542 may decode an encoded media file provided by the media source 541. The media file of audio content may be encoded/decoded according to, for example, at least one of an MP3 scheme, an advanced audio coding (AAC) scheme, a Windows media audio (WMA) scheme, a Vorbis scheme, a free lossless audio codec (FLAC) scheme, an Opus scheme, an AC3 scheme, and an adaptive multi-rate wideband (AMR-WB) scheme, but the encoding/decoding scheme is not limited. The media file of video content may be encoded/decoded according to, for example, at least one of an H.26x scheme, a Windows media video (WMV) scheme, a Theora scheme, a VP3 scheme, a VP9 scheme, or an AV1 scheme, but the encoding/decoding scheme is not limited. The decoder 542 may decode an encoded media file according to at least one of the above-described decoding schemes.

According to an embodiment, the decoder 542 may provide the decoded signal to the voice recognition module 543 and the speaker 524. The speaker 524 may output a voice, based on the decoded signal. For example, the speaker 524 may output an analog-type signal as a voice. The voice recognition module 543 may detect a trigger voice, based on the decoded signal. The voice recognition module 543 may be configured to recognize a trigger voice and/or other types of voices in an embodiment. When the voice recognition module 543 is configured to detect a trigger voice only, the voice recognition module 543 may be implemented to be a relatively lightweight voice recognition module. According to implementation, the voice recognition module 543 may be implemented to also recognize a voice other than the trigger voice. In another embodiment, the voice recognition module 543 may perform ASR and NLU. In this case, the voice recognition module 543 may detect a command other the trigger voice from the media file, and this will be described below in more detail.

According to an embodiment, when a trigger voice is detected based on the media file, the voice recognition module 543 may transmit information indicating occurrence of the trigger voice to the electronic device 501 through the communication circuit 522. The corresponding information may be implemented in, for example, a flag type, but a presentation type is not limited.

According to an embodiment, the microphone 514 may convert an external voice into voice data and output the converted voice data. For example, the microphone 514 may convert an analog voice into an electrical signal and output the converted electrical signal. The voice recognition module 531 may detect the trigger voice, based on the voice data. The voice recognition module 531 may transfer the trigger voice and/or information indicating detection of the trigger voice to the command processor 532. For example, the command processor 532 is a module for processing an instruction, and may request processing of a voice from and/or transfer an instruction to an external device such as an AI server or an IoT server. Alternatively, the command processor 532 may directly perform an operation corresponding a command without involvement of an external electronic device.

According to an embodiment, the command processor 532 may receive the trigger voice and/or information indicating detection of the trigger voice from the voice recognition module 531. The command processor 532 may identify information indicating output of the trigger voice from the media device 502, from a communication signal received through the communication circuit 512. The command processor 532 may skip processing of additional voice data and/or the trigger voice recognized by the voice recognition module 531, based on information indicating output of the trigger voice from the media device 502.

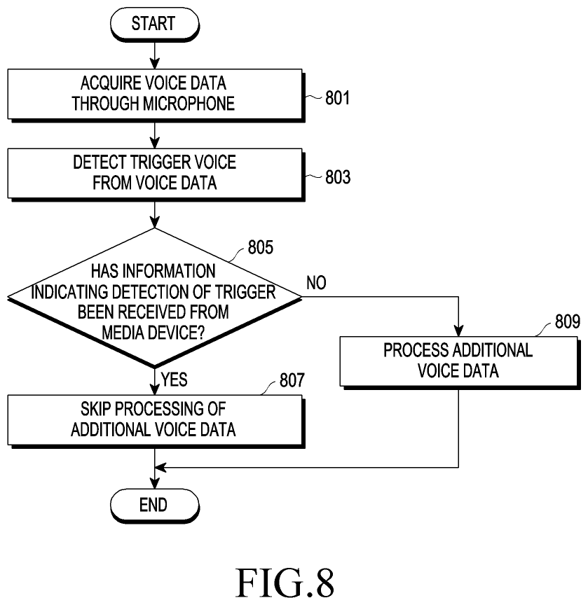

FIG. 8 is a flow chart illustrating a method for operating an electronic device according to an embodiment. The above-described operations among operations of FIG. 8 will be simply described.

According to an embodiment, in operation 801, the electronic device 501 may acquire voice data through a microphone. In operation 803, the electronic device 501 may detect a trigger voice from the voice data. In operation 805, the electronic device 501 may identify whether information indicating detection of the trigger voice is received from the media device 502.

When the detection of the trigger voice is identified (“Yes” in operation 805), the electronic device 501 may skip processing of additional voice data in operation 807. For example, even though the trigger voice is detected from the voice data, the electronic device 501 may not output a response voice. For example, the electronic device 501 may skip processing (e.g., a request for processing from an AI server and/or processing in the electronic device 501) of additional voice data following the trigger voice. When it is identified that no trigger voice is detected (“No” in operation 805), the electronic device 501 may process additional voice data in operation 809. In an example, the electronic device 501 may output a response voice (e.g., What can I do for you?) in response to the trigger voice (e.g., Hi, Bixby) through a speaker, and may process additional voice data (e.g., buy one soccer ball) that is additionally acquired thereafter. For example, the electronic device 501 may transfer processing of the additional voice data to the AI server, and may perform an operation corresponding to a result of the processing when the result of the processing is received from the AI server. For example, the electronic device 501 may directly recognize a command from the additional voice data, and may perform an operation corresponding to the command or transfer an instruction to an external device. In another example, the electronic device 501 may acquire the trigger voice and an additional voice (e.g., Hi, Bixby, buy one soccer ball) without output of a response voice therebetween. For example, the electronic device 501 may skip processing (e.g., a request for processing from the AI server and/or processing in the electronic device 501) of the additional voice data (e.g., buy one soccer ball) following the trigger voice.

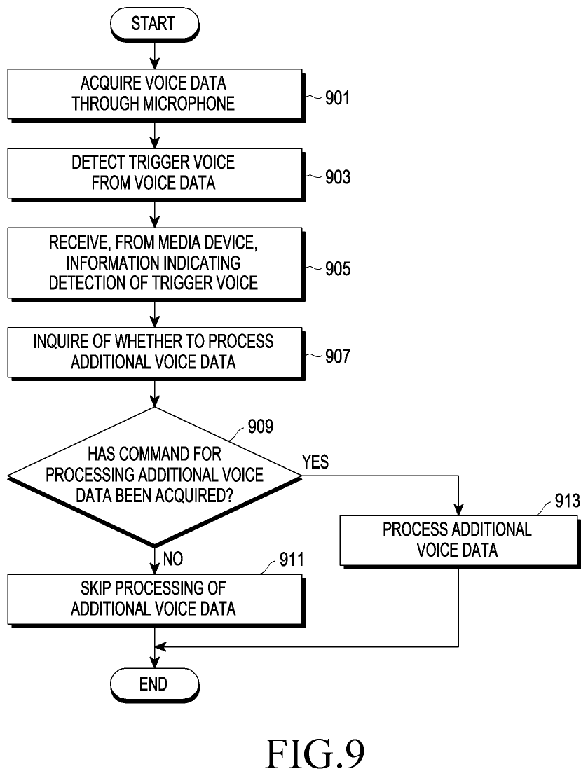

FIG. 9 is a flow chart illustrating a method for operating an electronic device according to an embodiment. The above-described operations among operations of FIG. 9 will be simply described.

According to an embodiment, in operation 901, the electronic device 501 may acquire voice data through a microphone. In operation 903, the electronic device 501 may identify detection of a trigger voice from the voice data. In operation 905, the electronic device 501 may receive information indicating detection of the trigger voice, from the media device. In operation 907, the electronic device 501 may inquire of whether to process additional voice data. For example, the electronic device 501 may output a voice such as “Are you sure you called me?” through a speaker, or may output a message inquiring of whether to process additional voice data through a display, but an output example is not limited.

According to an embodiment, in operation 909, the electronic device 501 may identify whether a command for processing additional voice data is acquired. For example, the electronic device 501 may identify whether a command for processing the additional voice data is acquired, based on a user identification voice (e.g., “Yes”), selection on an approval icon displayed on a display, or the like. When the command for processing the additional voice data is not acquired (“No” in operation 909), the electronic device 501 may skip processing of the additional voice data in operation 911. When the command for processing the additional voice data is acquired (“Yes” in operation 909), the electronic device 501 may process the additional voice data in operation 913.

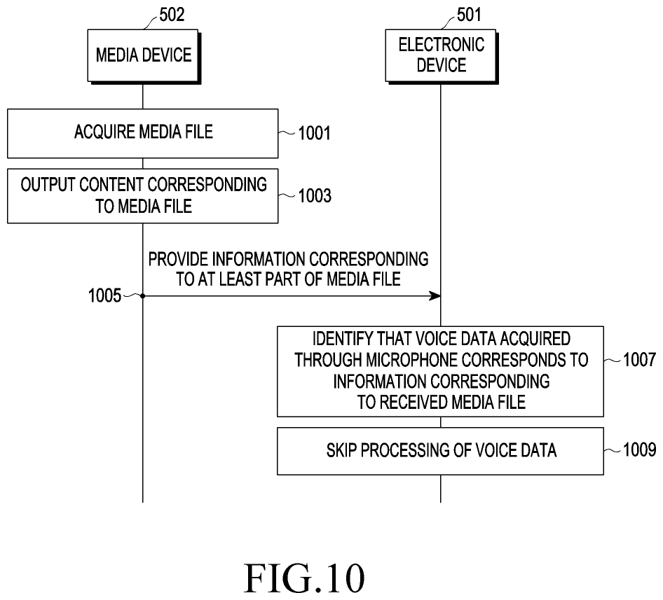

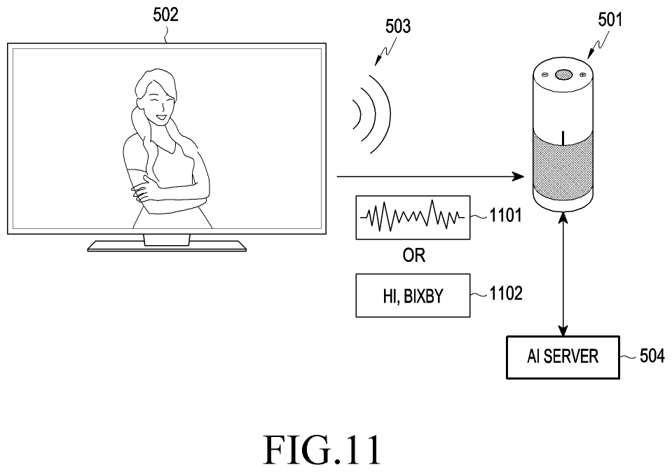

FIG. 10 is a flow chart illustrating a method for operating an electronic device and a media device according to an embodiment. An embodiment of FIG. 10 is described with reference to FIG. 11. FIG. 11 illustrates operations of an electronic device and a media device according to an embodiment. The above-described operations among operations of FIG. 10 will be simply described.

According to an embodiment, in operation 1001, the media device 502 may acquire a media file. In operation 1003, the media device 502 may output content corresponding to the media file. In operation 1005, the media device 502 may provide information corresponding to at least a part of the media file to the electronic device 501. For example, as shown in FIG. 11, the media device 502 may transmit a communication signal including information relating to a decoded signal 1101 to the electronic device 501. Alternatively, as shown in FIG. 11, the media device 502 may transmit a communication signal including information relating to text 1102 that is a result of voice recognition (e.g., a result of application of ASR) with respect to the decoded signal to the electronic device 501. For example, the media device 502 may transmit information relating to the media file to the electronic device 501 in real time, or may transmit information relating to the media file to the electronic device 501, based on detection of an event.

According to an embodiment, in operation 1007, the electronic device 501 may identify whether voice data acquired through a microphone corresponds to information corresponding to the received media file. For example, the electronic device 501 may identify whether similarity between the decoded signal 1101 and an analog signal output from the microphone exceeds a threshold. In another example, the electronic device 501 may identify whether the text 1102 detected from the media file corresponds to text recognized from the analog signal output from the microphone. In operation 1009, the electronic device 501 may skip processing of the voice data when the voice data acquired through the microphone corresponds to the received media file.

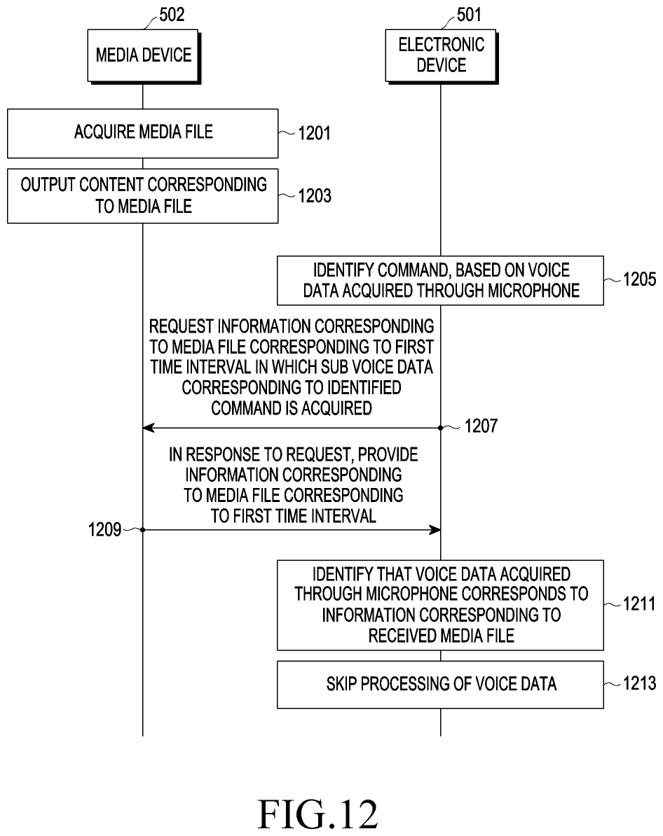

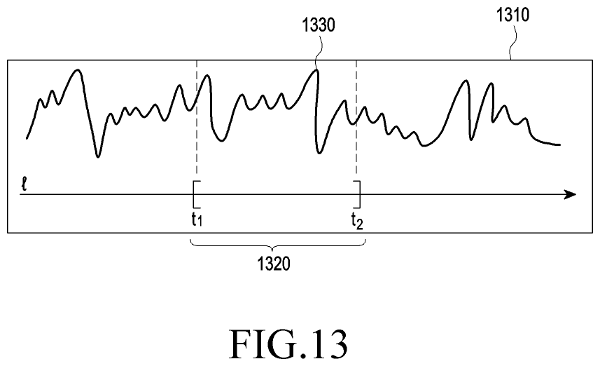

FIG. 12 is a flow chart illustrating a method for operating an electronic device and a media device according to an embodiment. An embodiment of FIG. 12 is described with reference to FIG. 13. FIG. 13 illustrates information relating to a media file according to an embodiment. The above-described operations among operations of FIG. 12 will be simply described.

According to an embodiment, in operation 1201, the media device 502 may acquire a media file. In operation 1203, the media device 502 may output content corresponding to the media file. In operation 1205, the electronic device 501 may identify a command, based on voice data acquired through a microphone. The electronic device 501 may identify a command, based on a voice recognition model which can perform ASR and NLU in the electronic device 501. Alternatively, the electronic device 501 may request at least a part of processing (e.g., ASR and/or NLU) of voice data from an external device (e.g., an AI server), and may receive a response to the request so as to identify the command. In operation 1207, the electronic device 501 may request, from the media device 502, information corresponding to a media file corresponding to a first time interval in which sub voice data corresponding to the identified command is acquired. For example, the electronic device 501 may identify that the media device 502 is located within a designated distance, or may identify that the electronic device 501 enters an area in which the media device 502 is disposed. In this case, the electronic device 501 may request, from the media device 502, information relating to a media file corresponding to the first time interval in which sub voice data corresponding to the identified command is acquired. In operation 1209, in response to the request, the media device 502 may provide information corresponding to the media file corresponding to the first time interval. For example, as shown in FIG. 13, the media device 502 may receive, from the electronic device 501, a request for information corresponding to a first time interval 1320, among the decoded signal 1310 corresponding to the media file. The media device 502 may provide a signal 1330 corresponding to the first time interval 1320 to the electronic device 501. Although not shown, the media device 502 may receive a request for text corresponding to the first time interval, and in this case, the media device 502 may provide the text corresponding to the first time interval to the electronic device 501.

According to an embodiment, in operation 1211, the electronic device 101 may identify that voice data acquired through a microphone corresponds to information corresponding to the received media file. For example, similarity between the signal 1330 corresponding to the first time interval 1320 in FIG. 13 and the voice data acquired through the microphone may be identified, and when the similarity has a value equal to or larger than a threshold, it may be identified that the voice data corresponds to information relating to the received media file. When it is identified that the voice data corresponds to the information relating to the received media file, the electronic device 101 may skip processing of the voice data in operation 1213.

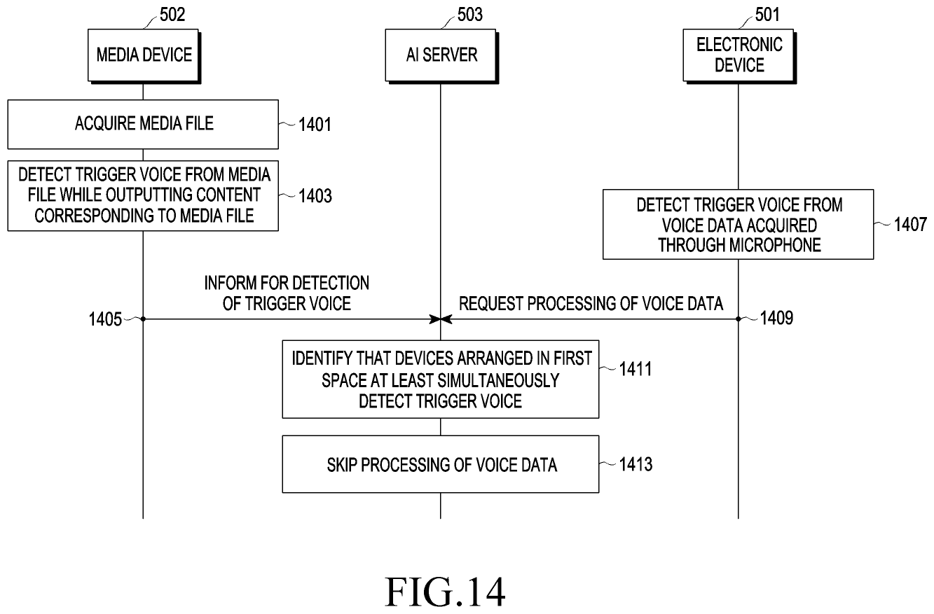

FIG. 14 is a flow chart illustrating a method for operating an electronic device, an AI server, and a media device according to an embodiment. The above-described operations among operations of FIG. 14 will be simply described.

According to an embodiment, in operation 1401, the media device 502 may acquire a media file. In operation 1403, the media device 502 may output content corresponding to the media file and detect a trigger voice from the media file. In operation 1405, the media device 502 may inform the AI server 503 of detection of the trigger voice. In operation 1407, the electronic device 501 may detect the trigger voice from the voice data acquired through a microphone. In operation 1409, the electronic device 501 may request the voice data, for example, processing of additional voice data input after the trigger voice, from the AI server 503.

According to an embodiment, in operation 1411, the AI server 503 may identify that devices arranged in a first space at least simultaneously detect a trigger voice. For example, the media device 502 and the electronic device 501 may transmit information relating to a time point at which a trigger voice is detected, to the AI server 503. The AI server 503 may manage information relating to the location of the media device 502 and information relating to the location of the electronic device 501, and accordingly, it may be identified that the electronic device 501 and the media device 502 are arranged together within a pre-designated size of range. When it is identified that the devices arranged in the first space at least simultaneously detect a trigger voice, the AI server 503 may skip processing of the voice data requested by the electronic device 501, in operation 1413. The AI server 503 may provide a message to the effect of skipping of processing of the requested voice data to the electronic device 501, and in this case, the electronic device 501 may output various types of messages indicating that processing of the voice data has been skipped by a voice output from the media device 502.

The electronic device according to the embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, and/or alternatives for a corresponding embodiment. With regard to the description of the drawings, similar reference numerals may be used to designate similar or relevant elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

The embodiments as set forth herein may be implemented as software (e.g., program) including one or more instructions that are stored in a storage medium (e.g., internal memory or external memory) that is readable by a machine (e.g., mater device or task execution device). For example, a processor of the machine (e.g., mater device or task execution device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

The disclosure relates to a voice recognition method of an electronic device, the method for recognizing a user voice and interpreting intention thereof in order to prevent performing an operation by a voice output from a media device. For example, a voice signal which is an analog signal may be received through a microphone, and a voice part may be converted into computer-readable text by means of an automatic speech recognition (ASR) model. The user's intention of speech may be acquired by interpretation of the converted text by means of a natural language understand (NLU) model. Here, the ASR model and the NLU model may be an artificial intelligence model. The artificial intelligence model may be processed by an artificial intelligence-dedicated processor which is designed to have a hardware structure specialized in processing an intelligence model. The artificial intelligence model may be created through learning. Here, the creation through learning means that a predefined operation rule or artificial intelligence model configured to perform a desired feature (or purpose) is created by training a basic artificial intelligence model by means of multiple learning data according to a learning algorithm. The artificial intelligence model may include multiple neural network layers. Each of the multiple neural network layers has multiple weight values, and a neural network operation is performed through an operation result of the previous layer and operation between the multiple weight values.

Linguistic understanding is a technology of recognizing and applying/processing human language/text, and may include natural language processing, machine translation, a dialog system, question and answering, speech recognition/synthesis, and the like.

1. An electronic device comprising:
a microphone configured to convert an external voice into voice data;
a communication circuit; and
at least one processor operatively connected to the microphone and the communication circuit,
wherein the at least one processor is configured to:
identify, from the voice data received from the microphone, a trigger voice configured to trigger a voice command function of the electronic device;
acquire, from an external electronic device through the communication circuit, a communication signal comprising information indicating output of content comprising the trigger voice from the external electronic device; and
skip processing of additional voice data acquired from the microphone after the trigger voice when output of content comprising the trigger voice from the external electronic device is identified based on the communication signal and the trigger voice is identified from the voice data.

2. The electronic device of claim 1, wherein the at least one processor is further configured to process the additional voice data acquired from the microphone after the trigger voice when the trigger voice is identified from the voice data and output of content comprising the trigger voice from the external electronic device is not identified.

3. The electronic device of claim 1, wherein the processing of the additional voice data comprises at least one of acquiring, based on the additional voice data, a command, performing the acquired command, or transmitting the acquired command to another external electronic device.

4. The electronic device of claim 1, wherein the processing of the additional voice data comprises at least one of requesting recognition of the additional voice data from another external electronic device, receiving information corresponding to the request, or performing an operation corresponding to the received information.

5. The electronic device of claim 1, wherein the at least one processor is further configured to, as at least a part of the skipping of the processing of the additional voice data acquired from the microphone after the trigger voice, skip the processing of the additional voice data when a difference between a first time point in which output of content comprising the trigger voice from the external electronic device is identified based on the communication signal and a second time point in which the trigger voice is identified from the voice data satisfies a designated condition.

6. The electronic device of claim 1, wherein the at least one processor is further configured to, as at least a part of the skipping of the processing of the additional voice data acquired from the microphone after the trigger voice:
output a message inquiring whether to process the additional voice data when output of content comprising the trigger voice from the external electronic device is identified based on the communication signal and the trigger voice is identified from the voice data; and
skip the processing of the additional voice data, based on failure of identifying a positive response in response to the inquiry message.

7. The electronic device of claim 6, wherein the at least one processor is further configured to process the additional voice data, based on identification of the positive response in response to the inquiry message.

8. The electronic device of claim 1, wherein the at least one processor is further configured to, as at least a part of the skipping of the processing of the additional voice data acquired from the microphone after the trigger voice:
skip output of a response voice responding to the trigger voice when a first corpus corresponding to the trigger voice is acquired, and skip the processing of the additional voice data when a second corpus corresponding to the additional voice data is acquired; or
skip the processing of the additional voice data when a third corpus comprising the trigger voice and the additional voice data is acquired.

9. A media device comprising:
a speaker configured to convert an electrical signal into a voice and output the converted voice;
a communication circuit; and
at least one processor operatively connected to the speaker and the communication circuit,
wherein the at least one processor is configured to:
acquire a media file;
control, by using information corresponding to the media file, to output a voice corresponding to the media file by using the speaker;
identify that the voice corresponding to the media file comprises a pre-designated trigger voice; and
control the communication circuit to transmit, to an external electronic device, a communication signal comprising information indicating that the voice corresponding to the media file comprises the trigger voice.

10. The media device of claim 9, wherein the at least one processor is further configured to, as at least a part of the identifying that the voice corresponding to the media file comprises the trigger voice,
identify a decoded signal obtained by decoding the media file;
identify text by performing voice recognition on the decoded signal; and
identify whether the identified text corresponds to text corresponding to the trigger voice.

11. An electronic device comprising:
a microphone configured to convert an external voice into voice data;
a communication circuit; and
at least one processor operatively connected to the microphone and the communication circuit,
wherein the at least one processor is configured to:
identify a command from the voice data received from the microphone;
receive, from an external electronic device through the communication circuit, information relating to a media file that is being output from the external electronic device;
identify whether the voice data corresponds to the information relating to the media file that is being output from the external electronic device;
process the command when the voice data fails to correspond to the information relating to the media file that is being output from the external electronic device; and
skip the processing of the command when the voice data corresponds to the information relating to the media file that is being output from the external electronic device.

12. The electronic device of claim 11, wherein the at least one processor is further configured to, as at least a part of the skipping of the processing of the command when the voice data corresponds to the information relating to the media file that is being output from the external electronic device, skip the processing of the command when a difference between a first time point in which the information relating to the media file that is being output from the external electronic device is acquired and a second time point in which the command is identified from the voice data satisfies a designated condition.

13. The electronic device of claim 11, wherein the at least one processor is further configured to, as at least a part of the skipping of the processing of the command when the voice data corresponds to the information relating to the media file that is being output from the external electronic device,
output a message inquiring whether to process the command when the voice data corresponds to the information relating to the media file that is being output from the external electronic device; and
skip the processing of the command, based on failure of identifying a positive response in response to the inquiry message.

14. The electronic device of claim 11, wherein the at least one processor is further configured to, as at least a part of the receiving of the information relating to the media file that is being output from the external electronic device, from the external electronic device, receive at least a part of at least a part of a signal obtained by decoding the media file that is being output, or at least a part of text corresponding to the decoded signal.

15. The electronic device of claim 11, wherein the at least one processor is further configured to, as at least a part of the receiving of the information relating to the media file that is being output from the external electronic device, from the external electronic device,
request, from the external electronic device through the communication circuit, information obtained during a time in which a sub-voice corresponding to the command is acquired; and
receive, in response to the request, the information relating to the media file that is being output from the external electronic device, through the communication circuit.
